(19) United States
(12) Patent Application Publication
(10) Pub. No.: US 2026/0270035 A1
(43) Pub. Date: Sep. 10, 2026

(54) VIRTUAL FREQUENCY-DOMAIN OCCUPATION INDICATION FOR A BEAM MEASUREMENT PREDICTION

(71) Applicant: QUALCOMM Incorporated, San Diego, CA (US)

(72) Inventors: Qiaoyu LI, Beijing (CN); Arumugam CHENDAMARAI KANNAN, San Diego, CA (US); Mahmoud TAHERZADEH BOROUJENI, San Diego, CA (US)

(21) Appl. No.: 19/480,013

(22) PCT Filed: Jun. 14, 2023
(86) PCT No.: PCT/CN2023/100158

§ 371 Date: Oct. 29, 2025

(51) Int. Cl. H04L 5/00; H04B 7/06; H04B 17/318

(52) U.S. Cl. CPC H04L 5/0098; H04B 7/0626; H04B 17/328

(57) ABSTRACT

The apparatus may receive, from a network node, a first indication of one or more spatial-domain resources for at least one channel characteristic prediction, receive, from the network node, a second indication of one or more frequency-domain resources for the at least one channel characteristic prediction for the one or more spatial-domain resources for which the network node refrains from transmitting a reference signal, and indicate, to the network node, at least one predicted channel characteristic value for at least one of the one or more frequency-domain resources and a corresponding at least one of the one or more spatial-domain resources.

### TECHNICAL FIELD

The present disclosure relates generally to communication systems, and more particularly, to wireless communication including a channel state information prediction.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device (e.g., a UE) or a component of a wireless device configured to receive, from a network node, a first indication of one or more resources for at least one channel characteristic prediction, receive, from the network node, a second indication of one or more frequency occupations for the at least one channel characteristic prediction for the one or more spatial-domain resources for which the network node refrains from transmitting a reference signal, and indicate, to the network node, at least one predicted channel characteristic value for at least one of the one or more frequency occupations and a corresponding at least one of the one or more resources.

In an aspect of the disclosure, a method, a computer-readable medium, and an apparatus are provided. The apparatus may be a network node, a network device or a component of a network node or network device configured to provide, for a wireless device, a first indication of one or more resources for at least one channel characteristic prediction, provide, for the wireless device, a second indication of one or more frequency occupations for the at least one channel characteristic prediction for the one or more resources, skip transmission of a reference signal in resources configured by the first indication and the second indication, and obtain, from the wireless device, a third indication of at least one predicted channel characteristic value for at least one of the one or more frequency occupations and a corresponding at least one of the one or more resources.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating the use of AI/ML-based beam management in accordance with some aspects of the disclosure.

FIG. 5 is a set of diagrams illustrating a set of measurement resources and an associated set of prediction resources in accordance with some aspects of the disclosure.

FIG. 6 is a set of diagrams illustrating an NZP-CSI-RS resource configuration (e.g., an NZP-CSI-RS-Resource IE) that may be used to configure virtual and/or prediction resources in accordance with some aspects of the disclosure.

FIG. 7 is a set of diagrams illustrating a method that may be used to configure virtual and/or prediction resources in accordance with some aspects of the disclosure.

FIG. 8 is a call flow diagram illustrating a method of indicating a frequency domain occupation associated with prediction resources in accordance with some aspects of the disclosure.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an apparatus or a UE.

FIG. 13 is a diagram illustrating an example of a hardware implementation for a network entity or network node.

FIG. 14 is a diagram illustrating an AI/ML algorithm for wireless communication.

### DETAILED DESCRIPTION

In some aspects of wireless communication, wireless devices (e.g., UEs, base stations, network devices, etc.) may monitor for communication and/or transmission failures associated with one or more beams (e.g., spatial-domain resources or directional transmissions). Failures associated with the one or more beams, in some aspects, may be detected and/or identified based on measurements. Each measurement may introduce overhead and power consumption (e.g., at a UE or other battery-powered wireless device) associated with receiving and decoding reference signals associated with the monitoring. Accordingly, the accuracy of the measurements may be limited based on restrictions on overhead and/or power consumption and may lead to erroneous determinations of beam quality. Additionally, throughput may be affected by a latency associated with the time involved in detecting beam measurements and switching to an alternate beam. Accordingly, predictive beam measurements (e.g., as an example of one aspect of predictive beam management more generally) may be introduced in some aspects to improve throughput by reducing overhead, power consumption, and latency and by increasing the accuracy of beam measurements. Specifically, aspects of predictive beam management may include prediction of non-measured beam qualities which may be associated with reduced overhead and power consumption. For example, by predicting beam qualities for beams for which the network does not transmit reference signals, predictive beam management techniques may eliminate the overhead associated with the non-transmitted and/or omitted reference signals and may eliminate the power consumption associated with receiving and decoding a reference signal.

In some aspects, the predictive beam management techniques may further allow for better accuracy by generating predictions based on more than a single measurement (e.g., based on an artificial intelligence (AI)/machine learning (ML) (AI/ML) model applied to a set of measurements or known conditions). Latency may also be improved, in association with some aspects of predictive beam management, based on being able to generate the predictions (e.g., predicted channel qualities associated with a blockage and/or failure) before a physical measurement is made and analyzed to determine whether the beam has failed.

Aspects presented herein provide for improved beam measurements by a network indicating frequency resources for beam predictions for which the network does not transmit a reference signal. In some aspects, a UE may predict one or more values for providing to a base station in a channel state information (CSI) report. The predicted values may include one or more of a reference signal received power (RSRP) or a signal to noise ratio (SINR) (e.g., a layer 1 (L1) RSRP or L1-SINR). Typically, a reported L1-RSRP and/or L1-SINR may be reported for a set of channel measurement resources (CMRs) or interference measurement resources (IMRs). In some aspects, the CMRs and/or IMRs may include, or indicate, one or more spatial-domain resources (e.g., beams or transmission directions and widths) associated with one or more sets of frequency-domain resources (e.g., associated with a frequency range within an active bandwidth part (BWP) or specific frequency-domain resources specified in a frequency domain occupation configuration) associated with a set of reference signals to be measured to determine channel qualities to be reported. In some aspects, calculating L1-RSRPs and/or L1-SINRs for an indicated set of CMRs and/or IMRs may include calculating a linear average power per resource element (RE) over all REs carrying reference signals (RSs) configured for RSRP and/or SINR measurements (e.g., REs identified by, or associated with, the CMRs/IMRs). Accordingly, due to frequency selectivity, measured L1-RSRPs and/or L1-SINRs may be different for different sets of RSs (e.g., different CSI-RSs) occupying different frequency-domain resources (e.g., different BWPs or different frequency ranges within a same BWP).

Because calculated L1-RSRP and/or L1-SINR values depend on the associated frequency-domain resource occupation (e.g., the CMRs or IMRs) for which the L1-RSRP and/or L1-SINR are calculated, when the UE is asked to calculate and/or report L1-RSRPs and/or L1-SINRs, an associated frequency-domain resource occupation should be also identified or indicated. A base station, in association with a CSI report configuration or a request for a CSI report (e.g., for the L1-RSRP, for the L1-SINR, or for a channel quality indicator (CQI)), may indicate the frequency-domain resource occupation associated with CMRs and/or IMRs used to transmit RSs as the frequency-domain resource occupation for which to calculate and report the L1-RSRP and/or L1-SINR values. If a base station transmits, for a set of prediction resources (e.g., beams or spatial-domain resources and/or frequency-domain resources) not used to transmit RSs, a CSI report configuration or a request for a CSI report, the UE may not be able to implicitly determine the frequency-domain resource occupation for which to calculate and report the L1-RSRP and/or L1-SINR values. For example, the frequency-domain resource occupation for which to calculate and report the predicted L1-RSRP and/or L1-SINR values may be, or may be related to, any of a frequency-domain resource occupation associated with one or more synchronization signal blocks (SSBs), a BWP, or a whole bandwidth. Based on the indicated frequency-domain resource occupation for which to calculate and report the L1-RSRP and/or L1-SINR values, the UE may select an appropriate AI/ML model and appropriate inputs (e.g., measurements of transmissions relate to one or more different types of signals such as a CSI-RS, an SSB, a physical downlink shared channel (PDSCH), a physical downlink control channel (PDCCH), or a DMRS associated with one or more of the PDSCH or PDCCH) to the selected AI/ML model.

Various aspects relate generally to indicating a frequency-domain resource occupation (e.g., via a frequency occupation configuration such as indicated in a CSI-frequency domain occupation configuration or a frequency band field) for a CSI report associated with reporting predicted values. Some aspects more specifically relate to indicating, from a network device to a wireless device via a first indication, one or more spatial-domain (prediction or virtual) resources for which to predict at least one channel characteristic and, via a second indication, one or more frequency-domain (prediction or virtual) resources for the at least one channel characteristic prediction for the one or more spatial-domain resources. Based on the indicated one or more spatial-domain resources and the one or more frequency-domain resources, a wireless device may report to the network device at least one predicted channel characteristic value for at least one of the one or more frequency-domain resources and a corresponding at least one of the one or more spatial-domain resources. In some aspects, the wireless device may predict at least one channel characteristic for the one or more frequency-domain resources and corresponding one or more spatial-domain resources without reception of a set of reference signals in resources configured for the at least one channel characteristic prediction.

Particular aspects of the subject matter described in this disclosure can be implemented to realize one or more of the following potential advantages. In some examples, by indicating one or more sets of frequency-domain resources associated with one or more spatial-domain resources, the described techniques can be used to facilitate predictive beam management and realize the reduced overhead, power consumption, and latency associated with predictive beam management.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

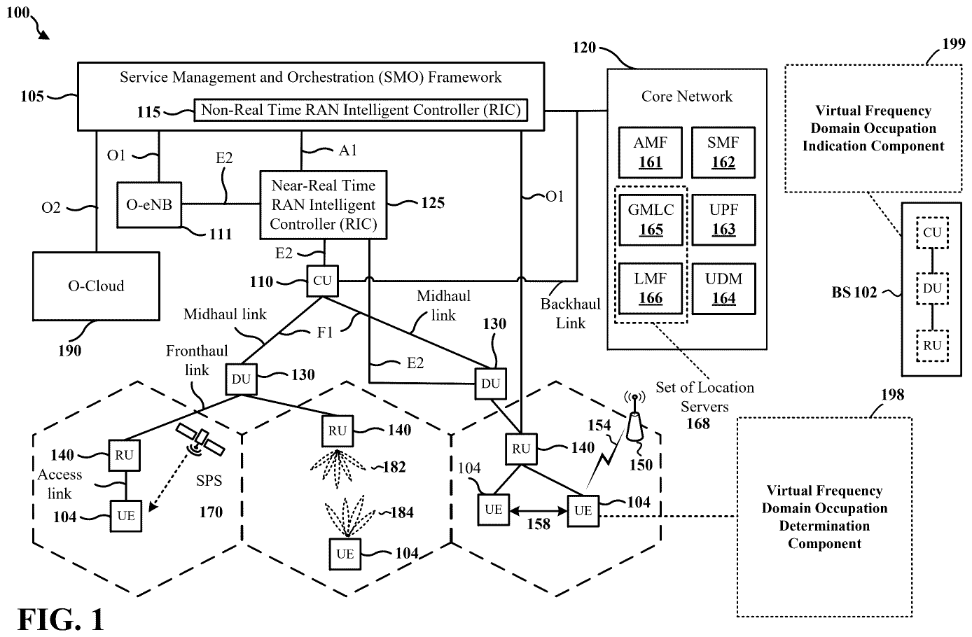

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, AI/ML workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming.

The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a virtual frequency domain occupation determination component 198 that may be configured to receive, from a network node, a first indication of one or more resources for at least one channel characteristic prediction, receive, from the network node, a second indication of one or more frequency occupations for the at least one channel characteristic prediction for the one or more resources for which the network node refrains from transmitting a reference signal, and indicate, to the network node, at least one predicted channel characteristic value for at least one of the one or more frequency occupations and a corresponding at least one of the one or more resources. In certain aspects, the base station 102 may have a virtual frequency domain occupation indication component 199 that may be configured to provide, for a wireless device, a first indication of one or more resources for at least one channel characteristic prediction, provide, for the wireless device, a second indication of one or more frequency occupations for the at least one channel characteristic prediction for the one or more resources, skip transmission of a reference signal in resources configured by the first indication and the second indication, and obtain, from the wireless device, a third indication of at least one predicted channel characteristic value for at least one of the one or more frequency occupations and a corresponding at least one of the one or more resources. While aspects of the disclosure may relate to 5G NR, aspects may be applicable to other aspects of wireless communication.

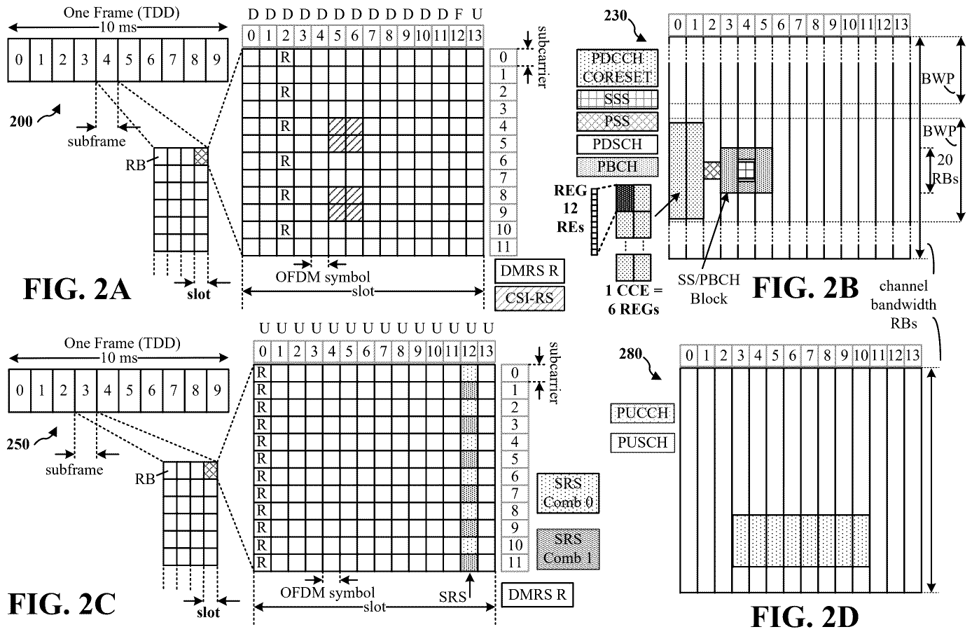

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

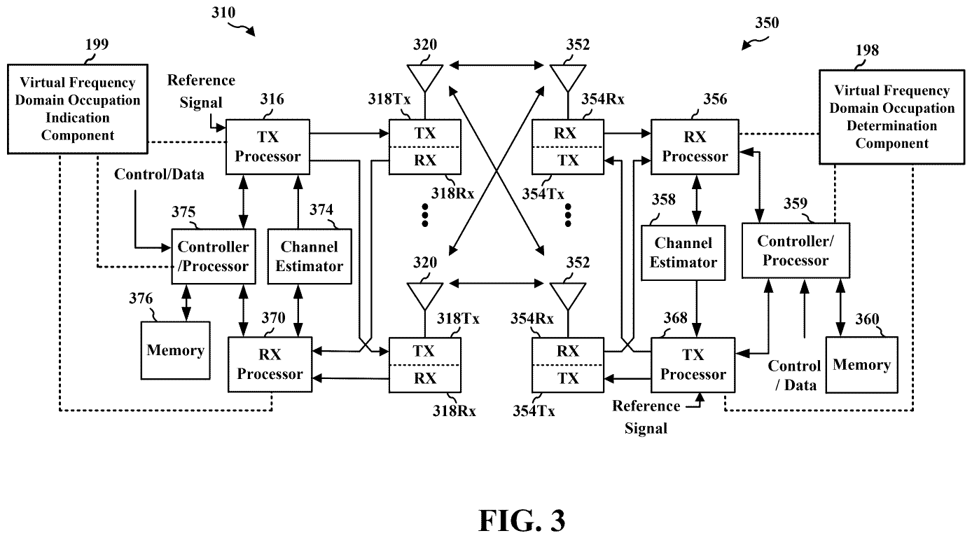

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the virtual frequency domain occupation determination component 198 of FIG. 1.

At least one of the TX processor 316, the RX processor 370, and the controller/processor 375 may be configured to perform aspects in connection with the virtual frequency domain occupation indication component 199 of FIG. 1.

The UE and the network may perform various aspects of beam management in order to select a beam for transmission and reception. The UE and the network may perform various aspects of beam management in order to select a beam for transmission and reception, e.g., as described in connection with 182 and 184 in FIG. 1. A base station and a UE may perform beam training to determine the best receive and transmit directions for each of the base station and the UE. The transmit and receive directions for the base station may or may not be the same. The transmit and receive directions for the UE may or may not be the same.

In response to different conditions, the beams used to transmit and receive communication between the UE and the base station may be switched. In some examples, the base station may send a transmission that triggers a beam switch by the UE. For example, the base station may indicate a TCI state change, and in response, the UE may switch to using a new beam for the new TCI state of the base station. Switching beams may allow for an improved exchange of communication between the UE and the base station by ensuring that the transmitter and receiver use the same configured set of beams for communication.

In some aspects, beam management may be performed using a tracking reference signal (TRS), e.g., for a UE in an RRC inactive or RRC idle state. For initial access, a UE may use an SSB, e.g., with a wide beam sweeping procedure to identify a beam to use for initial access. For CBRA, a UE may use an RO and a preamble that corresponds to the selected SSB/beam. In an RRC connected state, the UE and/or network may perform various aspects of beam management, e.g., including a P1, P2, and P3 procedure using SSB or CSI-RS measurements; a U1, U2, and U3 procedure using SRS transmissions and measurement, L1-RSRP reporting. The network may configure one or more TCI state configurations for the UE, and may indicate a TCI state for the UE from the configured set of TCI states. In some aspects, the UE may provide L1-SINR reporting, which may reduce overhead and latency and allow for CC group beam updates or faster UL beam updates. In some aspects, the UE may communicate with the network using unified TCI states, L1/L2 centric mobility (which may also be referred to an LTM), dynamic TCI updates, and/or uplink multi-panel selection, MPE migration, further beam management latency reduction, etc. Beam management may be employed for particular scenarios, such as high speed (e.g., HST), SFN, mTRP, among other examples. Based on measurements, a UE may perform a BFD process and may perform a BFR process. In some aspects, the BFD or BFR may be for a PCell or a PSCell. BFD may be based on a BFD-RS) and a PDCCH BLER. The BFR may be based on a CFRA. For an SCell, the BFD and BFR may include a link recovery request via an SR, or a MAC-CE based BFR for the SCell. If the BFR is unsuccessful, the UE may identify a radio link failure.

Some wireless communication may include the use of AI or ML at the network and/or at the UE. Among various examples, AI/ML may be used for beam management at a UE and/or a network, including for performing beam predictions in a time domain and/or spatial domain. The use of an AI/ML model may reduce latency or overhead and may improve the accuracy of beam selection. Models may be provided that support various levels of network and UE collaboration and to support various use cases. The use of an AI/ML model may include various aspects such as model training, model deployment, model inference, model monitoring, and model updating.

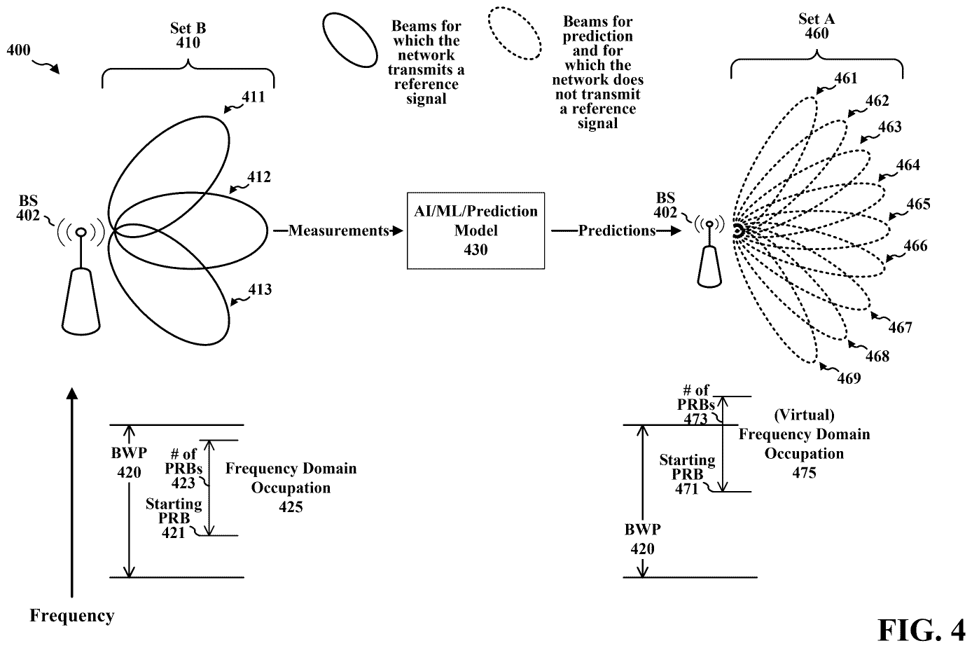

FIG. 4 is a diagram 400 illustrating the use of AI/ML-based beam management in accordance with some aspects of the disclosure. For AI/ML-based beam management, different beam management cases may be supported for characterization and baseline performance evaluations. For example, in one beam management case (BM-Case1), spatial-domain downlink beam prediction for a first set of beams (Set A 460 including narrow beam 461, narrow beam 462, narrow beam 463, narrow beam 464, narrow beam 465, narrow beam 466, narrow beam 467, narrow beam 468, and narrow beam 469) may be based on measurement results of a second set of beams (Set B 410 including wide beam 411, wide beam 412, and wide beam 413). In another beam management case (BM-Case2), temporal downlink beam prediction for Set A 460 may be based on the historic measurement results of Set B 410. For both BM-Case1 and BM-Case2, the predicted measurements for the beams in Set A 460 may be for the same frequency range as the historic measurement results for Set B 410. In some aspects (not illustrated), for BM-Case1, Set B 410 may be a subset of Set A 460. In other aspects, Set A 460 and Set B 410 may have different characteristics, such as different beam widths and/or different communication directions (e.g., Set A 460 includes narrow beams 461-469 and Set B 410 includes wide beams 411-413). In further aspects, Set A 460 may be for downlink beam prediction and Set B 410 may be for downlink beam measurement.

In an aspect in which an AI/ML model (e.g., AI/ML/prediction model 430) may be utilized at the UE for BM-Case1, L1 signaling may be utilized to report various information of AI/ML model inference (predictions) to the network. Such information may include, the beam(s) that are based on the output of AI/ML model inference, the predicted L1-RSRP corresponding to the beam(s), etc. In an aspect in which an AI/ML model may be utilized at the UE for BM-Case2, L1 signaling may be utilized to report various information of AI/ML model inference to the network. Such information may include the beam(s) of N future time instance(s) that are based on the output of the AI/ML model, where Nis any positive integer, the predicted L1-RSRP corresponding to the beam(s), information about the timestamp corresponding to the reported beam(s), etc. In aspects in which an AI/ML model may be utilized at the UE for both BM-Case1 and BM-Case2, UE-side model monitoring, network side model monitoring, or hybrid model monitoring may be utilized. For UE-side model monitoring, the UE may monitor the performance metric(s) and make decision(s) pertaining to model selection, activation, deactivation, switching, or fallback operation(s). For network-side model monitoring, the network may monitor the performance metric(s) and make decision(s) pertaining to model selection, activation, deactivation, switching, or fallback operation(s). For hybrid model monitoring, the UE may monitor the performance metric(s) and the network may make decision(s) pertaining to model selection, activation, deactivation, switching, or fallback operation(s), or vice versa. In aspects in which an AI/ML model may be utilized at the network for both BM-Case1 and BM-Case2, the network may monitor the performance metric(s) and make decision(s) pertaining to model selection, activation, deactivation, switching, or fallback operation(s). In such aspects, beam measurements and reporting may also be performed for model monitoring and/or the UE may report the measurement results of more than four beams in one reporting instance.

As discussed above, in some aspects of predictive beam management, a UE may predict one or more values for providing to a base station 402 in a CSI report. The predicted values may include one or more of a RSRP or a SINR (e.g., a L1-RSRP or L1-SINR). Typically, a reported L1-RSRP and/or L1-SINR may be reported for a set of CMRs or IMRs. The CMRs and/or IMRs, in some aspects, may refer to, or be specified in reference to, at least one CSI-RS and/or SSB configuration and may inherit characteristics (e.g., spatial transmission filter characteristics and/or frequency occupations) of the referenced CSI-RS and/or SSB. In some aspects, the CMRs and/or IMRs may include, or indicate, one or more spatial transmission filter characteristics associated with beams (e.g., codebook-based or non-codebook based beams associated with transmission directions and widths) that may be referred to generally as spatial-domain resources in the description below. The CMRs and/or IMRs and/or indicated spatial-domain resources, in some aspects, may additionally include, indicate, or be associated with one or more sets of frequency-domain resources (e.g., associated with a frequency range within an active BWP or specific frequency-domain resources specified in a frequency domain occupation, or frequency occupation, configuration) associated with a set of reference signals to be measured to determine channel qualities to be reported.

For example, the CMRs and/or IMRs may be associated with the spatial-domain resources in Set B 410 and frequency-domain resources (e.g., REs and/or PRBs) within an active BWP 420. The frequency-domain resources within the active BWP 420, in some aspects, may be associated with a frequency occupation such as frequency domain occupation 425 that may be indicated via a starting PRB 421 and a number of PRBs 423. In the discussion below, the terms ‘frequency domain occupation’ or ‘frequency-domain resources’ may be used interchangeably with frequency occupation to indicate that the frequency occupation indicates, or is associated with, a set of resources in a frequency domain, e.g., REs and/or PRBs. In some aspects, the frequency domain occupation may be indicated to the UE in a frequency occupation configuration such as a CSI frequency occupation IE (e.g., which may be referred to as a CSI-FrequencyOccupation IE) that may indicate a starting RB (e.g., a startingRB) field and a number of RBs (e.g., a nrofRBs field). In some aspects, the frequency occupation configuration may be indicated in a frequency band field for a CSI report.

In some aspects, calculating L1-RSRPs and/or L1-SINRs for an indicated set of CMRs and/or IMRs may include calculating a linear average power per RE over all REs carrying RSs configured for RSRP and/or SINR measurements (e.g., REs identified by, or associated with, the CMRs/IMRs). Accordingly, due to frequency selectivity, measured L1-RSRPs and/or L1-SINRs may be different for different sets of RSs (e.g., different CSI-RSs) occupying different frequency-domain resources (e.g., different BWPs or different frequency ranges within a same BWP).

Because calculated L1-RSRP and/or L1-SINR values depend on the associated frequency-domain resource occupation (e.g., the CMRs or IMRs) for which the L1-RSRP and/or L1-SINR are calculated, when the UE is asked to calculate and/or report L1-RSRPs and/or L1-SINRs, an associated frequency-domain resource occupation should be also identified or indicated. Typically, a base station, in association with a CSI report configuration or a request for a CSI report (e.g., for the L1-RSRP, for the L1-SINR, or for a CQI), may indicate the frequency-domain resource occupation associated with CMRs and/or IMRs used to transmit RSs as the frequency-domain resource occupation for which to calculate and report the L1-RSRP and/or L1-SINR values. Alternatively, after receiving a CSI report configuration or a request for a CSI report (e.g., for the L1-RSRP, for the L1-SINR, or for a CQI) and in the absence of a contradictory indication, a UE may assume the frequency-domain resource occupation associated with CMRs and/or IMRs used to transmit RSs is the frequency-domain resource occupation for which to calculate and report the L1-RSRP and/or L1-SINR values. However, if a base station transmits a CSI report configuration or a request for a CSI report indicating a set of prediction resources (e.g., beams or spatial-domain resources and/or frequency-domain resources) not used to transmit RSs, there may be confusion as to a frequency-domain resource occupation for which to calculate and report the L1-RSRP and/or L1-SINR values. For example, the frequency-domain resource occupation for which to calculate and report the predicted L1-RSRP and/or L1-SINR values may be, or may be related to, any of a frequency-domain resource occupation associated with one or more SSBs, a BWP, or a whole bandwidth. Based on the indicated frequency-domain resource occupation for which to calculate and report the L1-RSRP and/or L1-SINR values, the UE may select an appropriate AI/ML model and appropriate inputs (e.g., measurements of transmissions relate to one or more different types of signals such as a CSI-RS, an SSB, a PDSCH, a PDCCH, or a DMRS associated with one or more of the PDSCH or PDCCH) to the selected AI/ML model.

As illustrated in diagram 400, spatial-domain measurement resources (e.g., Set B 410 including wide beams 411-413) and associated RSs associated with a frequency domain occupation 425 may be measured by a UE (not shown) and may be used to predict (e.g., using AI/ML/prediction model 430) channel characteristics for spatial-domain (prediction) resources (e.g., set A 460 including narrow beams 461-469). The prediction for at least one spatial-domain (prediction) resource (e.g., at least one beam in set A 460, or at least one of the narrow beams 461-469) may be made in association with a (virtual) frequency domain occupation 475 (e.g., a set of frequency-domain resource specified using a starting RB 471 and a number of PRBs 473). As illustrated, the (virtual) frequency domain occupation 475 may be different from the frequency domain occupation 425 associated with the transmitted/measured resources. Additionally, each of the spatial-domain (prediction) resources may be associated with a corresponding frequency domain occupation that may be the same, or different, from frequency domain occupations of other spatial-domain (prediction) resources.

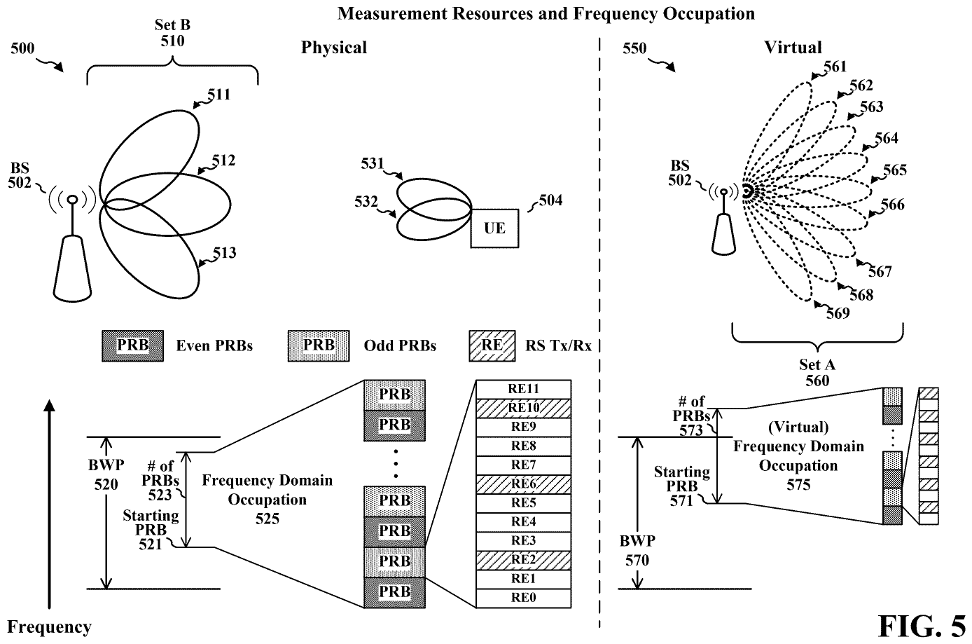

FIG. 5 is a set of diagrams illustrating a set of measurement resources and an associated set of prediction resources in accordance with some aspects of the disclosure. A first diagram 500 illustrates a set of physical and/or measurement resources used to transmit RSs from a base station 502 (e.g., as an example of a network node, a network entity, or network device). The set of physical and/or measurement resources may be associated with and/or include spatial-domain resources in Set B 510 including wide beam 511, wide beam 512, and wide beam 513, and may be associated with frequency-domain resources in an active BWP 520 associated with frequency domain occupation 525 that may be indicated based on a starting PRB 521 and a number of PRBs 523. A UE 504 may measure the RSs transmitted via the set of physical and/or measurement resources in association with a set of spatial-domain resources (e.g., receive beam 531 and/or receive beam 532). As described in relation to FIG. 4, the UE 504 may generate a set of predicted values associated with one or more of a set of virtual and/or prediction resources. The virtual and/or prediction resources may be associated with and/or include virtual and/or prediction spatial-domain resources in Set A 560 including narrow beam 561, narrow beam 562, narrow beam 563, narrow beam 564, narrow beam 565, narrow beam 566, narrow beam 567, narrow beam 568, and narrow beam 569. The set of predicted values may be associated with a (virtual) frequency domain occupation 575 that may be associated with PRBs that include PRBs within an active BWP 570 that is the same as the active BWP 520 as well as PRBs that are outside an active BWP 570 indicated by a starting PRB 571 and a number of PRBs 573.

As illustrated in diagram 500, the frequency domain occupation 525 may be associated with all the PRBs within the frequency range associated with the frequency domain occupation 525 or with a subset of the PRBs (e.g., the even PRBs and/or the odd PRBs). Each PRB of the frequency domain occupation may be associated with a (sub) set of REs used to transmit RSs (e.g., a set of REs associated with a reference RE (RE2) and an interval (4 REs). Similarly, diagram 550 illustrates that the (virtual) frequency domain occupation 575 may be associated with all the PRBs within the frequency range associated with the frequency domain occupation 575 or with a subset of the PRBs (e.g., the even PRBs and/or the odd PRBs). Each PRB of the frequency domain occupation may be associated with a (sub) set of virtual REs (e.g., a set of REs associated with a reference RE (RE1) and an interval (2 REs) that are associated with expected RSs for potential communication scheduled for transmission via the virtual and/or prediction resources.

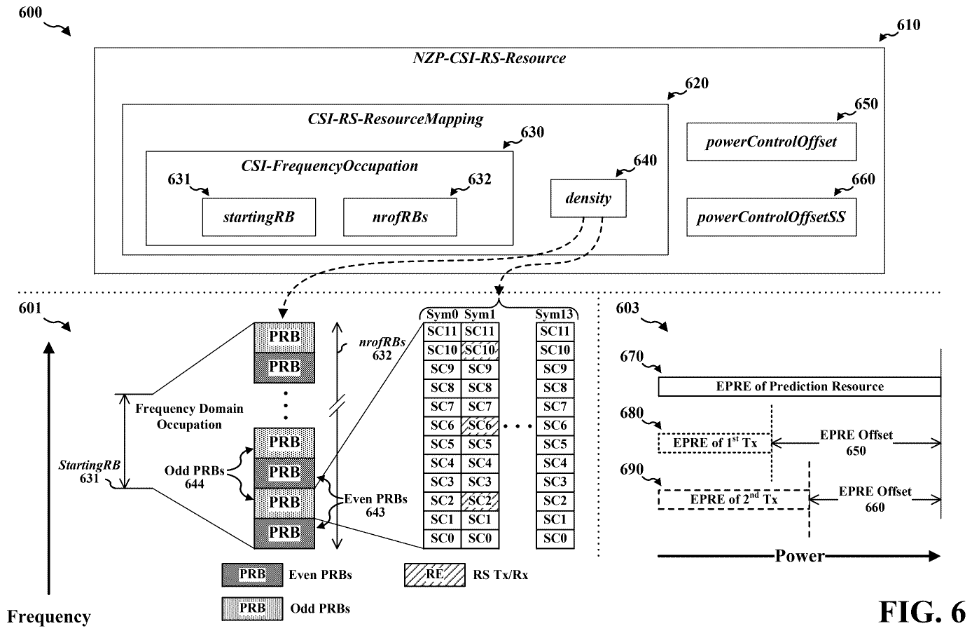

FIG. 6 is a set of diagrams illustrating an NZP-CSI-RS resource configuration (e.g., an NZP-CSI-RS-Resource IE) that may be used to (explicitly) configure virtual and/or prediction resources (e.g., a frequency domain occupation associated with a set of (spatial-domain) prediction resources) in accordance with some aspects of the disclosure. Diagram 600 illustrates a set of configurations that may be included in an NZP-CSI-RS resource configuration (e.g., the NZP-CSI-RS-Resource IE 610). Diagram 601 and diagram 603 illustrate characteristics of a CSI RS resource that may be configured by components of the NZP-CSI-RS-Resource IE 610.

Diagram 601 illustrates that a CSI-RS resource mapping configuration (e.g., CSI-RS-ResourceMapping IE 620) associated with, or included in, an NZP-CSI-RS resource configuration (e.g., the NZP-CSI-RS-Resource IE 610) may be used by the network to configure the resource element mapping of a CSI-RS resource in time-and-frequency domain. The CSI-RS-ResourceMapping IE 620, in some aspects, may include a CSI frequency occupation configuration (e.g., CSI-FrequencyOccupation IE 630) that may be used to configure the frequency domain occupation of a channel state measurement and/or prediction resource (e.g., a spatial-domain resource, an NZP-CSI-RS resource associated with an NZP-CSI-RS-Resource IE, or a CSI interference measurement resource associated with a CSI-IM-Resource IE). For example, the CSI-FrequencyOccupation IE 630, in some aspects, may specify a starting PRB (e.g., startingRB field 631) indicating a PRB where the first CSI resource starts in relation to a reference and/or common resource block (e.g., common resource block #0 (CRB #0)) on a common resource block grid. Additionally, the CSI-FrequencyOccupation IE 630, in some aspects, may specify a number of PRBs (e.g., nrofRBs field 632) across which an associated CSI resource spans.

For CSI-RS measurement resources, values for startingRB field 631 may range from 0 to one less than a maximum number of PRBs (e.g., may be within the range {0 . . . maxNrofPhysicalResourceBlocks−1}) and values for nrofRBs field 632 may range from 24 to one more than a maximum number of PRBs (e.g., may be within the range {0 . . . maxNrofPhysicalResourceBlocks+1}) where, for a configured value larger than the width of a corresponding (e.g., active) BWP, the UE may assume that the actual CSI-RS bandwidth is equal to (or limited to) the width of the BWP. However, in some aspects associated with prediction (or virtual) resources, the frequency domain occupation configuration (e.g., CSI-FrequencyOccupation IE 630) may indicate a frequency domain occupation that is (at least partially) outside of an associated (or active) BWP and/or that is larger (includes a greater range of frequencies) than the associated BWP by allowing the starting PRB (e.g., startingRB field 631) to take a negative value and either the starting PRB or the number of PRBs (e.g., nrofRBs field 632) to take a value higher than one less/more than a maximum number of PRBs to indicate a frequency domain occupation that is (at least partially) outside of an associated (or active) BWP and/or that is larger (includes a greater range of frequencies) than the associated BWP. This may be possible for prediction (or virtual) resources (as opposed to actual measurement resources) as they are not associated with RSs actually transmitted within the virtual frequency domain occupation indicated in frequency domain occupation configuration (e.g., CSI-FrequencyOccupation IE 630).

The CSI-RS resource mapping configuration (e.g., CSI-RS-ResourceMapping IE 620) associated with, or included in, a non-zero-power channel state information reference signal (NZP-CSI-RS) resource configuration (e.g., the NZP-CSI-RS-Resource IE 610) may further include a density value (e.g., associated with a density field 640 in the CSI-RS-ResourceMapping IE 620) measured in RE per port per PRB and may indicate the REs associated with a measurement and/or a prediction (e.g., a set of REs associated with predicted values for at least one channel characteristic). The density value may be one of 0.5 (dot5), one, or three where allowed values may depend on an associated number of ports (whether physical or virtual). For example, a density value of 0.5 (or dot5) may be associated with half of the PRBs (e.g., either the even PRBs 643 or odd PRBs 644) within a range of frequencies associated with the frequency domain occupation including a (virtual) RS. In some aspects, a higher/larger density value may be associated with all the PRBs (e.g., both the even PRBs 643 and the odd PRBs 644) within the range of frequencies associated with the frequency domain occupation including a (virtual) RS and may be used to identify a location of one or more RSs within each PRB (e.g., a time-and-frequency resource (e.g., an RE) within a PRB associated with a symbol (e.g., Sym0-Sym13) and subcarrier (e.g., SC0-SC11) or set of symbols and subcarriers). For example, diagram illustrates that subcarriers 2, 6, and 10 (e.g., SC2, SC6, and SC10) in a second symbol (e.g., Sym1) may be indicated as including a RS (or as being associated with a virtual RS).

In some aspects, the one or more frequency-domain resources indicate a frequency domain occupation based on at least one of a first set of contiguous physical resource blocks (PRBs) in an active bandwidth part (BWP), a second set of non-contiguous (e.g., alternating) PRBs in the active BWP, each PRB within the active BWP, or a third set of PRBs spanning a frequency range that is greater than the active BWP. The indicated frequency domain occupation may be referred to in some aspects as a “virtual frequency domain occupation” as the base station does not actually transmit a reference signal in the indicated frequency domain. Different sets of frequency-domain resources, in some aspects, may be specified and/or indicated for (or as being associated with) different spatial-domain resources. For example, a first set of frequency-domain resources may include one of the first subset of contiguous PRBs in the active BWP or the second subset of non-contiguous (e.g., alternating) PRBs in the active BWP, and a second set of frequency-domain resources of the one or more sets of frequency-domain resources may include one of a third subset of contiguous PRBs in the active BWP or a fourth subset of non-contiguous (e.g., alternating) PRBs in the active BWP, where at least one of the first subset of contiguous PRBs is different from the third subset of contiguous PRBs or the second subset of alternating PRBs is different from the fourth subset of alternating PRBs. In some aspects, the one or more frequency-domain resources include multiple sets of contiguous PRBs in the active BWP or multiple sets of non-contiguous PRBs in the active BWP.

The NZP-CSI-RS resource configuration (e.g., the NZP-CSI-RS-Resource IE 610) may further include an indication of one or more energy per resource element (EPRE) offsets associated with the prediction. The EPRE offsets may be used in predicting at least one channel characteristic value for prediction resources associated with (or identified by) the NZP-CSI-RS resource configuration. For example, the NZP-CSI-RS resource configuration may include a power control offset configuration (e.g., a powerControlOffset field 650) indicating a value (e.g., in dB) associated with a power offset of PDSCH RE to NZP CSI-RS RE (e.g., indicating a difference, or offset, between a transmitted power associated with a single RE associated with a PDSCH transmission and a transmitted power (or virtual transmission power) associated with a single RE of the NZP CSI-RS). For example, referring to diagram 603, an EPRE 670 for a prediction resource may be indicated, via the power control offset configuration (e.g., the powerControlOffset field 650) to be greater than an EPRE 680 indicated for a first transmission (e.g., an RE associated with a PDSCH such as a RE carrying one of data, a DMRS, or a different RS). Similarly, the NZP-CSI-RS resource configuration may include a power control offset from a synchronization signal (SS) configuration (e.g., a powerControlOffsetSS field 660) indicating a value (e.g., in dB) associated with a power offset of NZP CSI-RS RE to SSS RE (e.g., indicating a difference, or offset, between a transmitted power (or virtual transmission power) associated with a single RE associated with the NZP CSI-RS and a transmitted power associated with a single RE of SSS (or other synchronization signal)). For example, referring to diagram 603, an EPRE 670 for a prediction resource may be indicated, via the power control offset from the SS configuration (e.g., the powerControlOffsetSS field 660) to be greater than an EPRE 690 indicated for a second transmission (e.g., an RE associated with a SS such as a SSB, PSS, and/or an SSS). While indicated to be a positive value (e.g., a (virtual) EPRE of the NZP CSI-RS that is greater than the EPRE of the PDSCH RE or SSS RE) the power control offset configurations (e.g., the powerControlOffset field 650 and/or the powerControlOffsetSS field 660) may indicate a negative value.

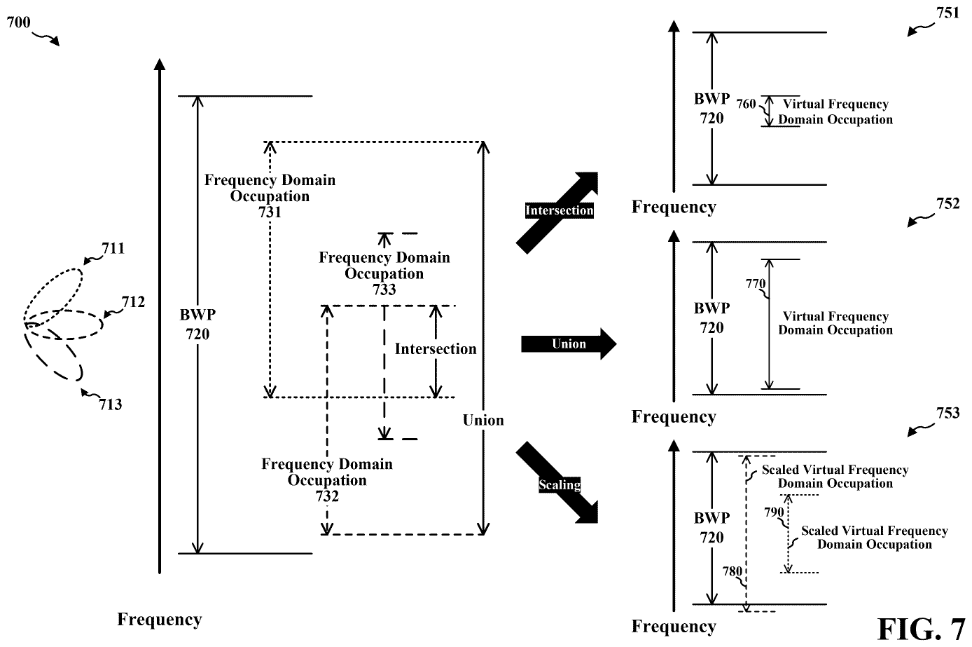

FIG. 7 is a set of diagrams illustrating a method that may be used to (implicitly) configure virtual and/or prediction resources (e.g., a frequency domain occupation associated with a set of (spatial-domain) prediction resources) in accordance with some aspects of the disclosure. Diagram 700 illustrates that a first set of measurement resources may include different spatial-domain resources, e.g., beam 711, beam 712, and beam 713 that may be associated with and/or correspond to, different frequency domain occupations within an active BWP 720, e.g., frequency domain occupation 731, frequency domain occupation 732, and frequency domain occupation 733, respectively. In some aspects, the spatial-domain resources, e.g., beams 711-713, associated with the measurement resources may be selected from a first set of beams (e.g., Set B beams) that do not include spatial-domain resources (e.g., Set A beams) associated with indicated prediction resources. Alternatively, or additionally, the spatial-domain resources, e.g., beams 711-713, associated with the measurement resources may include a subset of the spatial-domain resources associated with the indicated prediction resources.

Prediction resources, in some aspects, may be identified via a combination of explicit indications and determinations made based on information known at the UE. For example, spatial-domain prediction resources may be indicated via a CSI report setting or configuration (e.g., a CMR configuration or a channel prediction resource (CPR) configuration associated with the CSI report setting) while a frequency domain occupation associated with the spatial-domain prediction resources may be determined based on the measurement resources associated with predicting at least one predicted channel characteristic value for at least one prediction resource of the prediction resources (e.g., an L1-RSRP, L1-SINR, or CQI for a set of “K” best beams). In some aspects, a UE may be configured to determine the frequency domain occupation for the prediction resources based on a defined correspondence between the frequency domain occupation of the measurement resources and the determined (virtual) frequency domain occupation for the prediction resources. The determination, in some aspects, may be a single frequency domain occupation determination for the prediction resources as a whole. In some aspects, the determination of the frequency domain occupation for the prediction resources may include an independent frequency domain occupation determination for each of the spatial-domain prediction resources associated with the prediction resources).

In some aspects, as illustrated in diagram 751, a determined (virtual) frequency domain occupation 760 may be based on a defined (one-to-one) correspondence between an intersection of frequency domain occupations (e.g., frequency domain occupations 731-733) associated with the measurement resources and the determined (virtual) frequency domain occupation 760 for the prediction resources. As illustrated in diagram 752, the determined (virtual) frequency domain occupation 770 may be based on a defined (one-to-one) correspondence between a union of frequency domain occupations (e.g., frequency domain occupations 731-733) associated with the measurement resources and the determined (virtual) frequency domain occupation 770 for the prediction resources. Diagram 753 illustrates that, in some aspects, the determined (virtual) frequency domain occupation 770 may be based on a defined correspondence between one of the union or the intersection of the frequency domain occupations (e.g., frequency domain occupations 731-733) associated with the measurement resources and the determined (virtual) frequency domain occupation 780 or the determined (virtual) frequency domain occupation 790 for the prediction resources that includes a scaling factor that may be greater than, or less than, 1. For example, the determined (virtual) frequency domain occupation 780 (and the determined (virtual) frequency domain occupation 790) may represent a scaling factor of 1.2 (or a scaling factor of 0.6) applied to the union of frequency domain occupations (e.g., frequency domain occupations 731-733) corresponding to determined (virtual) frequency domain occupation 770. Alternatively, if the intersection of frequency domain occupations (e.g., frequency domain occupations 731-733) is used as the reference frequency domain occupation, the determined (virtual) frequency domain occupation 790 may represent a scaling factor of 2.5 applied to the reference frequency domain occupation.

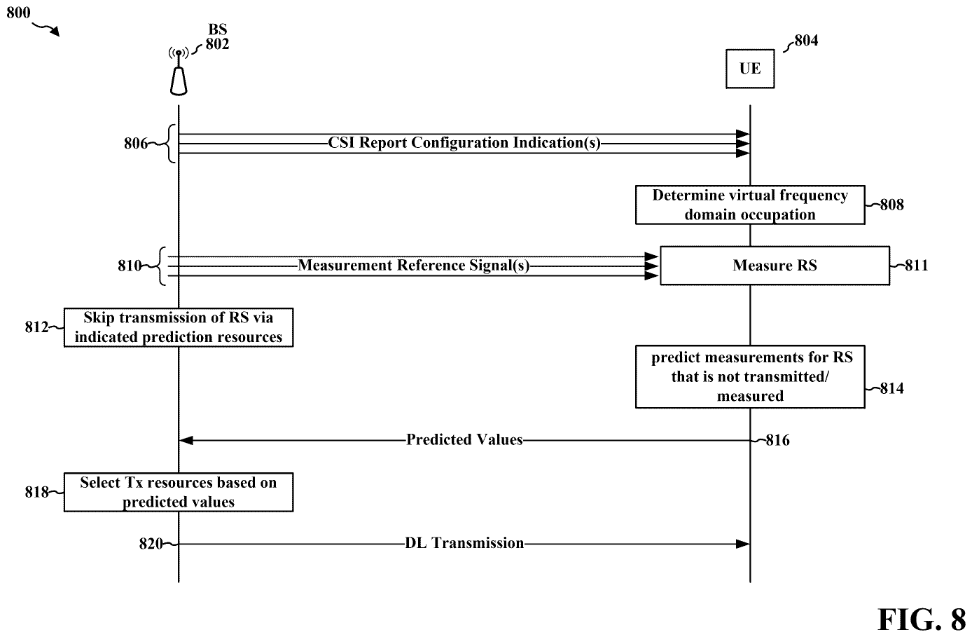

FIG. 8 is a call flow diagram 800 illustrating a method of indicating a frequency domain occupation associated with prediction resources in accordance with some aspects of the disclosure. In the following description, the functions ascribed to the base station 802, in some aspects, may be performed by one or more components of a network entity, a network node, or a network device (a single network device/node or a disaggregated network device/node as described above in relation to FIG. 1). Similarly, the functions ascribed to the UE 804, in some aspects, may be performed by one or more components of a wireless device supporting communication with a network device/node. Accordingly, references to “transmitting” in the description below may be understood to refer to a first component of the base station 802 (or the UE 804) outputting (or providing) an indication of the content of the transmission to be transmitted by a different component of the base station 802 (or the UE 804). Similarly, references to “receiving” in the description below may be understood to refer to a first component of the base station 802 (or the UE 804) receiving a transmitted signal and outputting (or providing) the received signal (or information based on the received signal) to a different component of the base station 802 (or the UE 804).

In some aspects, the base station 802 may transmit, and a UE 804 may receive, one or more indications 806 related to a predicted CSI report configuration. The one or more indications 806 may be related to prediction resources (e.g., a set of virtual resources associated with a CSI report including at least one predicted channel characteristic value for at least one of the prediction resources). For example, the one or more indications 806 may include a first indication of one or more spatial-domain resources for at least one channel characteristic prediction. In some aspects, the one or more indications 806 may further include a second indication of one or more frequency-domain resources for the at least one channel characteristic prediction for the one or more spatial-domain resources. The identified prediction resources indicated by the first and second indications, in some aspects, may not be used to transmit RSs. The second indication, in some aspects, may include an EPRE offset relative to at least one of an SSB (or SSS) EPRE, a transmitted NZP-CSI-RS EPRE, a PDSCH EPRE, or a DMRS EPRE used to predict at least one predicted channel characteristic value for at least one of the prediction resources.

In some aspects, the second indication of the one or more frequency-domain resources for the at least one channel characteristic prediction for the one or more spatial-domain resources, may be an indication of configuration information for measurement resources associated with (e.g., that form the basis of the prediction for) the predicted CSI report configuration that can serve as the basis for determining, at 808, the frequency domain occupation (e.g., frequency-domain resources) associated with the prediction resources. Alternatively, or additionally, the UE 804, in some aspects, may receive (either before or after receiving the one or more indications 806) configuration information for measurement resources associated with (e.g., that form the basis of the prediction for) the predicted CSI report configuration. For example, referring to FIGS. 4, 5, and 7, the UE 804 may receive an indication of the wide beams 411-413, the wide beams 511-513, and/or the beams 711-713 and the associated, or corresponding, frequency domain occupation, e.g., frequency domain occupation 425, 525, or 731-733, respectively.

The UE 804, in some aspects, may, at 808, determine a (virtual and/or prediction) frequency domain occupation associated with the prediction resources. The (virtual and/or prediction) frequency domain occupation associated with the prediction resources, in some aspects, may be determined by the base station 802 before or after transmitting the one or more indications 806 (e.g., for use in interpreting the reported values for the prediction resources). The determination at 808, in some aspects, may be based on the first indication and the second indication included in the one or more indications 806. For example, in some aspects, the determination at 808 may be based on an explicit indication of the (virtual and/or prediction) frequency domain occupation associated with the prediction resources as described in relation to FIG. 6. In some aspects, the determination at 808 may be based on an implicit indication of the (virtual and/or prediction) frequency domain occupation associated with the prediction resources as described in relation to FIG. 7.

The base station 802, may transmit, and the UE 804 may receive, a set of measurement RSs 810 associated with the measurement resources. In some aspects, at 812 the base station 802 may additionally skip, or omit, transmitting RSs via REs associated with the prediction resources. The UE 804, at 811, may measure the set of measurement RSs 810 and, based on the measurements, may predict, at 814 and without measurement, at least one channel characteristic value for at least one of the prediction resources (e.g., at least one spatial-domain resource and corresponding frequency-domain resources such as the (virtual and/or prediction) frequency domain occupation determined at 808). The prediction at 814, in some aspects, may be based on an AI/ML (or other prediction) model as described in relation to FIG. 4.

The UE 804 may transmit, and the base station 802 may receive, a set of predicted values 816 (e.g., included in, or in association with, a (predicted) CSI report). The predicted values may include one or more of a predicted L1-RSRP, L1-SINR, CQI, or other channel characteristic. The predicted values may be transmitted and/or reported for one of each prediction resource (e.g., each spatial-domain resource) or for a subset of the prediction resources (e.g., a set of the K prediction resources and/or spatial-domain resources associated with the best, or highest, predicted values). Based on the predicted values 816, the base station 802 may select transmission resources for a subsequent DL transmission 820 (e.g., a PDSCH transmission). The base station 802 may then transmit, and the UE 804 may receive, the subsequent DL transmission 820 via the resources selected at 818.

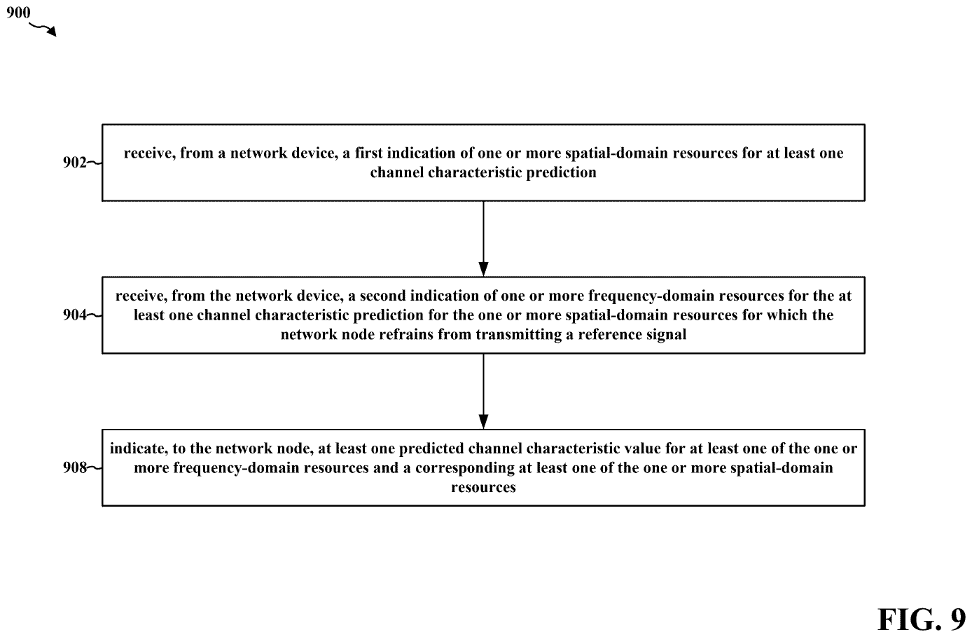

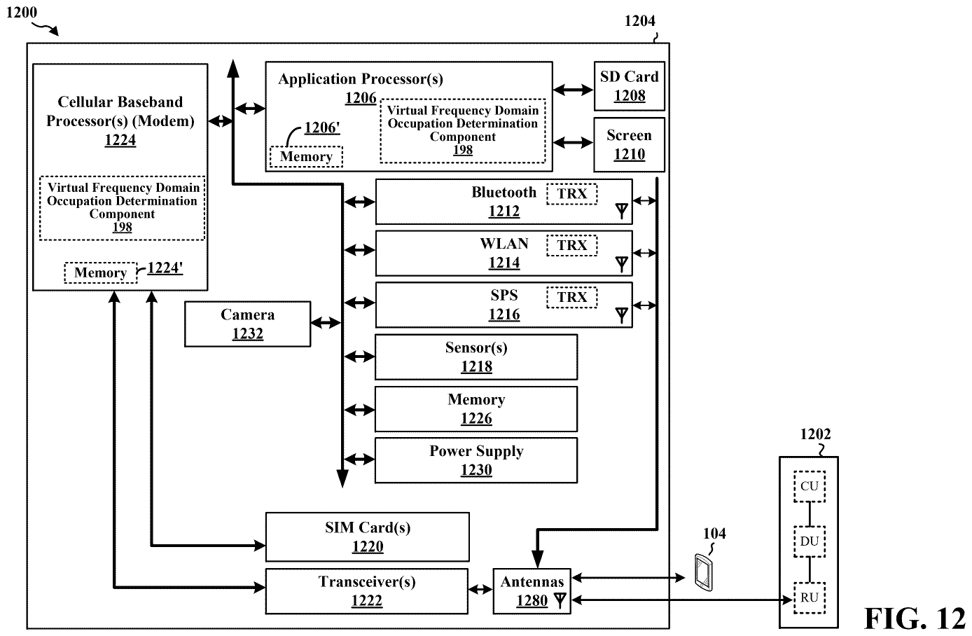

FIG. 9 is a flowchart 900 of a method of wireless communication. The method may be performed by a wireless device such as a UE (e.g., the UE 104, 504, 804; the apparatus 1204). At 902, the UE may receive, from a network node, a first indication of one or more spatial-domain resources for at least one channel characteristic prediction. For example, 902 may be performed by application processor(s) 1206, cellular baseband processor(s) 1224, transceiver(s) 1222, antenna(s) 1280, and/or virtual frequency domain occupation determination component 198 of FIG. 12. In some aspects, the first indication may be included in a CSI report setting configuration for prediction resources, a CMR configuration associated with the CSI report setting configuration for the prediction resources, or a CPR configuration associated with the CSI report setting configuration for the prediction resources. For example, referring to FIGS. 4, 5, 7, and 8, the UE 504 or 804 may receive an indication of the one or more indications 806 identifying the (virtual and/or prediction) spatial domain resources (e.g., narrow beams 461-469 or narrow beams 561-569).

At 904, the UE may receive, from the network node, a second indication of one or more frequency-domain resources for the at least one channel characteristic prediction for the one or more spatial-domain resources. For example, 904 may be performed by application processor(s) 1206, cellular baseband processor(s) 1224, transceiver(s) 1222, antenna(s) 1280, and/or virtual frequency domain occupation determination component 198 of FIG. 12. In some aspects, the network node may refrain from transmitting (and the UE may not receive) a RS (e.g., an actual RS) via the one or more frequency-domain resources for the at least one channel characteristic prediction for the one or more spatial-domain resources. The one or more frequency-domain resources, in some aspects, may be one or more sets of frequency-domain resources with each frequency-domain resource or set of frequency-domain resources corresponding to a frequency domain occupation as discussed above. In some aspects, the one or more frequency-domain resources may include different frequency-domain resources corresponding to different spatial-domain resources of the one or more spatial-domain resources such that predictions for different spatial-domain resources may be based on different frequency domain occupations. For example, referring to FIGS. 6 and 8, the UE 804 may receive the second indication of one or more frequency-domain resources for the at least one channel characteristic prediction for the one or more spatial-domain resources in the one or more indications 806 and the base station 802 may, at 812, skip transmission of (or refrain from transmitting) RSs via the frequency-domain resources for the one or more spatial-domain resources.

In some aspects, the second indication of the one or more frequency-domain resources may indicate a frequency domain occupation based on (or including) at least one of: a first set of contiguous PRBs in an active BWP, a second set of non-contiguous PRBs in the active BWP, each PRB within the active BWP, or a third set of PRBs spanning a frequency range that is greater than the active BWP. The one or more frequency-domain resources, in some aspects, may include multiple (different and/or independent) sets of contiguous PRBs in the active BWP or multiple (different and/or independent) sets of non-contiguous PRBs in the active BWP. The multiple (different and/or independent) sets of contiguous PRBs in the active BWP or the multiple (different and/or independent) sets of non-contiguous PRBs in the active BWP, in some aspects, may correspond to different spatial-domain (prediction and/or virtual) resources. In some aspects, the second indication of the one or more frequency-domain resources may indicate a frequency domain occupation based on (or including) a subset of REs of one or more PRBs. The second indication, in some aspects, may further indicate at least one EPRE offset relative to a corresponding at least one of an SS (e.g., an SSB or SSS) EPRE, a transmitted NZP-CSI-RS EPRE, a PDSCH EPRE, or a DMRS EPRE, and the at least one channel characteristic prediction may be based on the EPRE offset. For example, referring to FIGS. 4-8, the second indication of the one or more indications 806 may indicate the (virtual) frequency domain occupation 475, 575, 760, 770, 780, and/or 790; the PRBs or REs associated with the (virtual) frequency domain occupation via the NZP-CSI-RS-Resource IE 610 (or the related IEs and/or fields, e.g., CSI-RS-ResourceMapping IE 620, CSI-FrequencyOccupation IE 630, startingRB field 631, nrofRBs field 632, and/or density field 640); and/or one or more EPRE offsets (e.g., via powerControlOffset field 650, and powerControlOffsetSS field 660).

The second indication of the one or more frequency-domain resources, in some aspects, may be based on an explicit indication. For example, in some aspects, the second indication may be included in at least one NZP-CSI-RS resource configuration (e.g., an NZP-CSI-RS-Resource IE). In some aspects, each NZP-CSI-RS resource configuration (e.g., NZP-CSI-RS-Resource IE) of the at least one NZP-CSI-RS resource configuration(s) indicates a starting PRB and a number of PRBs for corresponding frequency-domain resources of the one or more frequency-domain resources. The corresponding frequency-domain resources, in some aspects, may include PRBs outside an active BWP based on the starting PRB and the number of PRBs indicated for at least the corresponding frequency-domain resources. The at least one EPRE offset, in some aspects, may be included in at least one of a power control offset configuration (e.g., a powerControlOffset IE) or a power control offset SS configuration (e.g., a powercontrolOffsetSS IE), and the at least one of the power control offset configuration or the power control offset SS configuration may be included in an NZP-CSI-RS resource configuration (e.g., NZP-CSI-RS-Resource IE). For example, the power control offset configuration (e.g., a powerControlOffset IE), in some aspects, may be used to configure an EPRE offset associated with a prediction resource and a PDSCH EPRE when predicting and/or determining a CQI while a power control offset SS configuration (e.g., a powercontrolOffsetSS IE) may be used to configure an EPRE offset associated with the prediction resource and an SS (e.g., SSB or SSS) EPRE or some other CSI-RS's EPRE when predicting and/or determining L1-RSRPs (or L1-SINRs). In some aspects, first frequency-domain resources of the one or more frequency-domain resources may include a subset of non-contiguous PRBs in an active BWP, and the second indication may indicate the subset of non-contiguous PRBs in the active BWP by indicating one of an even PRB occupation or an odd PRB occupation via a density configuration (e.g., a density field) included in a CSI-RS resource mapping configuration (e.g., a CSI-RS-ResourceMapping IE) that is in turn included in the NZP-CSI-RS resource configuration (e.g., the NZP-CSI-RS-Resource IE). A subset of REs of one or more PRBs, in some aspects, may be indicated via the density configuration (e.g., a density field) included in a CSI-RS resource mapping configuration (e.g., a CSI-RS-ResourceMapping IE) that is in turn included in the NZP-CSI-RS resource configuration (e.g., the NZP-CSI-RS-Resource IE). For example, referring to FIGS. 4-6 and 8, the second indication of the one or more indications 806 may indicate the (virtual) frequency domain occupation 475 or 575; the PRBs or REs associated with the (virtual) frequency domain occupation via the NZP-CSI-RS-Resource IE 610 (or the related IEs and/or fields, e.g., CSI-RS-ResourceMapping IE 620, CSI-FrequencyOccupation IE 630, startingRB field 631, nrofRBs field 632, and/or density field 640); and/or at least one EPRE offsets (e.g., via powerControlOffset field 650, and powerControlOffsetSS field 660).

The second indication of the one or more frequency-domain resources, in some aspects, may be an indication of one or more frequency-domain measurement resources having a defined correspondence to the one or more frequency-domain (virtual and/or prediction) resources. The correspondence, in some aspects, may be defined in one of a standard such that the UE is pre-configured with (an indication of) the defined correspondence (or a plurality of selectable defined correspondences) or in a configuration message (e.g., an RRC message) providing the defined correspondence (or indicating a selected defined correspondence from the plurality of selectable defined correspondences). In some aspects, the defined correspondence may be based on (e.g., a reference set of frequency-domain resources may be defined based on) one of a union or intersection of the one or more frequency-domain measurement resources. The defined correspondence, in some aspects, may include a correspondence between the one or more frequency-domain (virtual and/or prediction) resources and a reference set of frequency-domain resources based on a scaling factor applied to one of a union of the one or more frequency-domain measurement resources or an intersection of the one or more frequency-domain measurement resources. In some aspects, based on the one or more frequency-domain measurement resources, the UE may determine one of a union or intersection of the one or more frequency-domain measurement resources (e.g., frequency-domain resources that may be used as reference frequency-domain resources) and may then apply a scaling factor (e.g., 0<s≤sₘₐₓ, where sₘₐₓ may be greater than, or equal to, 1) to determine, generate, and/or identify a reference set of frequency-domain resources (or a reference frequency domain occupation) corresponding to the one or more frequency-domain (virtual and/or prediction) resources. In some aspects, the identified one or more frequency-domain (virtual and/or prediction) resources may be applied to, or used for, the prediction resources (e.g., may be associated with, or applied to, each of the spatial-domain (virtual and/or prediction) resources). In some aspects, the UE may be configured with at least one defined EPRE offset relative to, or from, a corresponding at least one of an SS (e.g., an SSB or SSS) EPRE, a transmitted NZP-CSI-RS EPRE, a PDSCH EPRE, or a DMRS EPRE. For example, an EPRE offset associated with a prediction resource, in some aspects, may be defined for a PDSCH EPRE and may be used when predicting and/or determining a CQI while an EPRE offset associated with a prediction resource, in some aspects, may be defined for an SS (e.g., SSB or SSS) EPRE or some other CSI-RS's EPRE (e.g., RSs associated with the one or more frequency-domain measurement resources) when predicting and/or determining L1-RSRPs (or L1-SINRs). For example, referring to FIGS. 4, 5, 7, and 8, the second indication of the one or more indications 806 may indicate the measurement resources (the wide beams 41-413 and 511-513, or the beam 711-713 and the corresponding frequency domain occupations 425, 525, or 731-733) and the UE 804 may determine, at 808, the (virtual and/or prediction) frequency-domain resources (or frequency domain occupation) associated with the prediction resources based on a defined correspondence between the indicated measurement resources and the (virtual and/or prediction) frequency-domain resources (or frequency domain occupation) as described in relation to FIG. 7.

The UE, in some aspects, may receive a set of RSs associated with a set of CMRs and/or IMRs and perform and/or make measurements on the received RSs. The specific spatial-domain resources and frequency-domain resources used to transmit the received RSs and the associated measurements may be stored by the UE as measurement data. The UE may use the stored measurement data to be used as inputs to one of an AI/ML or prediction model. For example, referring to FIGS. 4, 5, 7, and 8, the UE 804 may receive the set of measurement RSs 810 (e.g., via the measurement resources indicated in one of the one or more indications 806 such as the wide beams 41-413 and 511-513, or the beam 711-713 and the corresponding frequency domain occupations 425, 525, or 731-733) and may measure, at 811, the received set of measurement RSs 810.

Based on the measurements on the received RSs (e.g., the measurement data), the UE may predict at least one channel characteristic value based on resources indicated in the first indication and the second indication. As discussed above, predicting the at least one channel characteristic, in some aspects, may include using the at least one defined EPRE offset. In some aspects, predicting the at least one channel characteristic may include using an indicated EPRE offset. For example, referring to FIGS. 4-8, the UE 804 may, at 814, predict, based on the measurements of the set of measurement RSs 810 at 811, the at least one channel characteristic value for at least one of the prediction resources (e.g., at least one spatial-domain resource and corresponding frequency-domain resources such as the narrow beams 461-469 or 561-569 and associated (virtual) frequency domain occupation 475, 575, 760, 770, 780, and/or 790; the PRBs or REs associated with the (virtual) frequency domain occupation via the NZP-CSI-RS-Resource IE 610 (or the related IEs and/or fields, e.g., CSI-RS-ResourceMapping IE 620, CSI-FrequencyOccupation IE 630, startingRB field 631, nrofRBs field 632, and/or density field 640); or (virtual and/or prediction) frequency domain occupation determined at 808). The prediction at 814, in some aspects, may be based on an AI/ML (or other prediction) model as described in relation to FIG. 4 and may further be based on the one or more EPRE offsets (e.g., configured via powerControlOffset field 650 and/or powerControlOffsetSS field 660 or previously defined and/or configured).

At 908, the UE may indicate, to the network node, the at least one predicted channel characteristic value for at least one of the one or more frequency-domain resources and a corresponding at least one of the one or more spatial-domain resources. For example, 908 may be performed by application processor(s) 1206, cellular baseband processor(s) 1224, and/or virtual frequency domain occupation determination component 198 of FIG. 12. In some aspects, the at least one predicted channel characteristic value associated with the at least one channel characteristic prediction for first frequency-domain resources of the one or more frequency-domain resources associated with a first spatial-domain resource of the one or more spatial-domain resources includes at least one of a predicted L1-RSRP that is based on a linear average of a predicted RSRP for at least one RE associated with the first frequency-domain resources, a predicted L1-SINR that is based on a linear average of a predicted SINR for the at least one RE associated with the first frequency-domain resources, or a CQI associated with the first spatial-domain resource. For example, referring to FIGS. 4-8, the UE 804 may transmit the set of predicted values 816. In some aspects, the set of predicted values 816 may include at least one predicted channel characteristic value for at least one of the prediction resources (e.g., at least one spatial-domain resource and corresponding frequency-domain resources such as the narrow beams 461-469 or 561-569 and associated (virtual) frequency domain occupation 475, 575, 760, 770, 780, and/or 790; the PRBs or REs associated with the (virtual) frequency domain occupation via the NZP-CSI-RS-Resource IE 610 (or the related IEs and/or fields, e.g., CSI-RS-ResourceMapping IE 620, CSI-FrequencyOccupation IE 630, startingRB field 631, nrofRBs field 632, and/or density field 640); or (virtual and/or prediction) frequency domain occupation determined at 808).

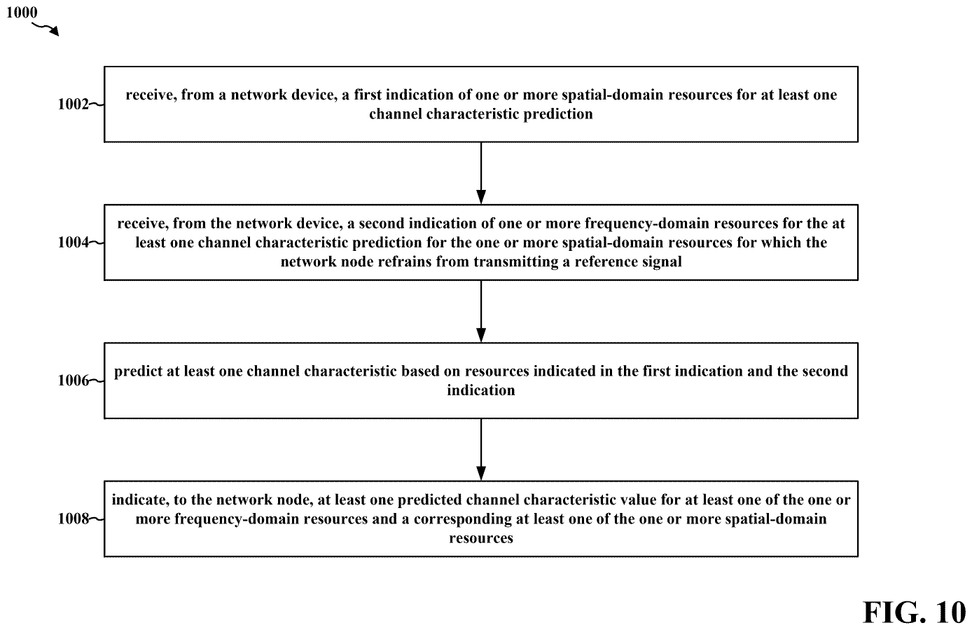

FIG. 10 is a flowchart 1000 of a method of wireless communication. The method may be performed by a wireless device such as a UE (e.g., the UE 104, 504, 804; the apparatus 1204). At 1002, the UE may receive, from a network node, a first indication of one or more spatial-domain resources for at least one channel characteristic prediction. For example, 1002 may be performed by application processor(s) 1206, cellular baseband processor(s) 1224, transceiver(s) 1222, antenna(s) 1280, and/or virtual frequency domain occupation determination component 198 of FIG. 12. In some aspects, the first indication may be included in a CSI report setting configuration for prediction resources, a CMR configuration associated with the CSI report setting configuration for the prediction resources, or a CPR configuration associated with the CSI report setting configuration for the prediction resources. For example, referring to FIGS. 4, 5, 7, and 8, the UE 504 or 804 may receive an indication of the one or more indications 806 identifying the (virtual and/or prediction) spatial domain resources (e.g., narrow beams 461-469 or narrow beams 561-569).

At 1004, the UE may receive, from the network node, a second indication of one or more frequency-domain resources for the at least one channel characteristic prediction for the one or more spatial-domain resources. For example, 1004 may be performed by application processor(s) 1206, cellular baseband processor(s) 1224, transceiver(s) 1222, antenna(s) 1280, and/or virtual frequency domain occupation determination component 198 of FIG. 12. In some aspects, the network node may refrain from transmitting (and the UE may not receive) a RS (e.g., an actual RS) via the one or more frequency-domain resources for the at least one channel characteristic prediction for the one or more spatial-domain resources. The one or more frequency-domain resources, in some aspects, may be one or more sets of frequency-domain resources with each frequency-domain resource or set of frequency-domain resources corresponding to a frequency domain occupation as discussed above. In some aspects, the one or more frequency-domain resources may include different frequency-domain resources corresponding to different spatial-domain resources of the one or more spatial-domain resources such that predictions for different spatial-domain resources may be based on different frequency domain occupations. For example, referring to FIGS. 6 and 8, the UE 804 may receive the second indication of one or more frequency-domain resources for the at least one channel characteristic prediction for the one or more spatial-domain resources in the one or more indications 806 and the base station 802 may, at 812, skip transmission of (or refrain from transmitting) RSs via the frequency-domain resources for the one or more spatial-domain resources.

In some aspects, the second indication of the one or more frequency-domain resources may indicate a frequency domain occupation based on (or including) at least one of: a first set of contiguous PRBs in an active BWP, a second set of non-contiguous PRBs in the active BWP, each PRB within the active BWP, or a third set of PRBs spanning a frequency range that is greater than the active BWP. The one or more frequency-domain resources, in some aspects, may include multiple (different and/or independent) sets of contiguous PRBs in the active BWP or multiple (different and/or independent) sets of non-contiguous PRBs in the active BWP. The multiple (different and/or independent) sets of contiguous PRBs in the active BWP or the multiple (different and/or independent) sets of non-contiguous PRBs in the active BWP, in some aspects, may correspond to different spatial-domain (prediction and/or virtual) resources. In some aspects, the second indication of the one or more frequency-domain resources may indicate a frequency domain occupation based on (or including) a subset of REs of one or more PRBs. The second indication, in some aspects, may further indicate at least one EPRE offset relative to a corresponding at least one of an SS (e.g., an SSB or SSS) EPRE, a transmitted NZP-CSI-RS EPRE, a PDSCH EPRE, or a DMRS EPRE, and the at least one channel characteristic prediction may be based on the EPRE offset. For example, referring to FIGS. 4-8, the second indication of the one or more indications 806 may indicate the (virtual) frequency domain occupation 475, 575, 760, 770, 780, and/or 790; the PRBs or REs associated with the (virtual) frequency domain occupation via the NZP-CSI-RS-Resource IE 610 (or the related IEs and/or fields, e.g., CSI-RS-ResourceMapping IE 620, CSI-FrequencyOccupation IE 630, startingRB field 631, nrofRBs field 632, and/or density field 640); and/or one or more EPRE offsets (e.g., via powerControlOffset field 650, and powerControlOffsetSS field 660).

The second indication of the one or more frequency-domain resources, in some aspects, may be based on an explicit indication. For example, in some aspects, the second indication may be included in at least one NZP-CSI-RS resource configuration (e.g., an NZP-CSI-RS-Resource IE). In some aspects, each NZP-CSI-RS resource configuration (e.g., NZP-CSI-RS-Resource IE) of the at least one NZP-CSI-RS resource configuration(s) indicates a starting PRB and a number of PRBs for corresponding frequency-domain resources of the one or more frequency-domain resources. The corresponding frequency-domain resources, in some aspects, may include PRBs outside an active BWP based on the starting PRB and the number of PRBs indicated for at least the corresponding frequency-domain resources. The at least one EPRE offset, in some aspects, may be included in at least one of a power control offset configuration (e.g., a powerControlOffset IE) or a power control offset SS configuration (e.g., a powercontrolOffsetSS IE), and the at least one of the power control offset configuration or the power control offset SS configuration may be included in an NZP-CSI-RS resource configuration (e.g., NZP-CSI-RS-Resource IE). For example, the power control offset configuration (e.g., a powerControlOffset IE), in some aspects, may be used to configure an EPRE offset associated with a prediction resource and a PDSCH EPRE when predicting and/or determining a CQI while a power control offset SS configuration (e.g., a powercontrolOffsetSS IE) may be used to configure an EPRE offset associated with the prediction resource and an SS (e.g., SSB or SSS) EPRE or some other CSI-RS's EPRE when predicting and/or determining L1-RSRPs (or L1-SINRs). In some aspects, first frequency-domain resources of the one or more frequency-domain resources may include a subset of non-contiguous PRBs in an active BWP, and the second indication may indicate the subset of non-contiguous PRBs in the active BWP by indicating one of an even PRB occupation or an odd PRB occupation via a density configuration (e.g., a density field) included in a CSI-RS resource mapping configuration (e.g., a CSI-RS-ResourceMapping IE) that is in turn included in the NZP-CSI-RS resource configuration (e.g., the NZP-CSI-RS-Resource IE). A subset of REs of one or more PRBs, in some aspects, may be indicated via the density configuration (e.g., a density field) included in a CSI-RS resource mapping configuration (e.g., a CSI-RS-ResourceMapping IE) that is in turn included in the NZP-CSI-RS resource configuration (e.g., the NZP-CSI-RS-Resource IE). For example, referring to FIGS. 4-6 and 8, the second indication of the one or more indications 806 may indicate the (virtual) frequency domain occupation 475 or 575; the PRBs or REs associated with the (virtual) frequency domain occupation via the NZP-CSI-RS-Resource IE 610 (or the related IEs and/or fields, e.g., CSI-RS-ResourceMapping IE 620, CSI-FrequencyOccupation IE 630, startingRB field 631, nrofRBs field 632, and/or density field 640); and/or at least one EPRE offsets (e.g., via powerControlOffset field 650, and powerControlOffsetSS field 660).

The second indication of the one or more frequency-domain resources, in some aspects, may be an indication of one or more frequency-domain measurement resources having a defined correspondence to the one or more frequency-domain (virtual and/or prediction) resources. The correspondence, in some aspects, may be defined in one of a standard such that the UE is pre-configured with (an indication of) the defined correspondence (or a plurality of selectable defined correspondences) or in a configuration message (e.g., an RRC message) providing the defined correspondence (or indicating a selected defined correspondence from the plurality of selectable defined correspondences). In some aspects, the defined correspondence may be based on (e.g., a reference set of frequency-domain resources may be defined based on) one of a union or intersection of the one or more frequency-domain measurement resources. The defined correspondence, in some aspects, may include a correspondence between the one or more frequency-domain (virtual and/or prediction) resources and a reference set of frequency-domain resources based on a scaling factor applied to one of a union of the one or more frequency-domain measurement resources or an intersection of the one or more frequency-domain measurement resources. In some aspects, based on the one or more frequency-domain measurement resources, the UE may determine one of a union or intersection of the one or more frequency-domain measurement resources (e.g., frequency-domain resources that may be used as reference frequency-domain resources) and may then apply a scaling factor (e.g., 0<s≤sₘₐₓ, where sₘₐₓ may be greater than, or equal to, 1) to determine, generate, and/or identify a reference set of frequency-domain resources (or a reference frequency domain occupation) corresponding to the one or more frequency-domain (virtual and/or prediction) resources. In some aspects, the identified one or more frequency-domain (virtual and/or prediction) resources may be applied to, or used for, the prediction resources (e.g., may be associated with, or applied to, each of the spatial-domain (virtual and/or prediction) resources). In some aspects, the UE may be configured with at least one defined EPRE offset relative to, or from, a corresponding at least one of an SS (e.g., an SSB or SSS) EPRE, a transmitted NZP-CSI-RS EPRE, a PDSCH EPRE, or a DMRS EPRE. For example, an EPRE offset associated with a prediction resource, in some aspects, may be defined for a PDSCH EPRE and may be used when predicting and/or determining a CQI while an EPRE offset associated with a prediction resource, in some aspects, may be defined for an SS (e.g., SSB or SSS) EPRE or some other CSI-RS's EPRE (e.g., RSs associated with the one or more frequency-domain measurement resources) when predicting and/or determining L1-RSRPs (or L1-SINRs). For example, referring to FIGS. 4, 5, 7, and 8, the second indication of the one or more indications 806 may indicate the measurement resources (the wide beams 41-413 and 511-513, or the beam 711-713 and the corresponding frequency domain occupations 425, 525, or 731-733) and the UE 804 may determine, at 808, the (virtual and/or prediction) frequency-domain resources (or frequency domain occupation) associated with the prediction resources based on a defined correspondence between the indicated measurement resources and the (virtual and/or prediction) frequency-domain resources (or frequency domain occupation) as described in relation to FIG. 7.

The UE, in some aspects, may receive a set of RSs associated with a set of CMRs and/or IMRs and perform and/or make measurements on the received RSs. The specific spatial-domain resources and frequency-domain resources used to transmit the received RSs and the associated measurements may be stored by the UE as measurement data. The UE may use the stored measurement data to be used as inputs to one of an AI/ML or prediction model. For example, referring to FIGS. 4, 5, 7, and 8, the UE 804 may receive the set of measurement RSs 810 (e.g., via the measurement resources indicated in one of the one or more indications 806 such as the wide beams 41-413 and 511-513, or the beam 711-713 and the corresponding frequency domain occupations 425, 525, or 731-733) and may measure, at 811, the received set of measurement RSs 810.

At 1006, the UE may predict at least one channel characteristic value based on resources indicated in the first indication and the second indication. For example, 1006 may be performed by application processor(s) 1206, cellular baseband processor(s) 1224, and/or virtual frequency domain occupation determination component 198 of FIG. 12. As discussed above, predicting the at least one channel characteristic, in some aspects, may include using the at least one defined EPRE offset. In some aspects, predicting the at least one channel characteristic may include using an indicated EPRE offset. For example, referring to FIGS. 4-8, the UE 804 may, at 814, predict, based on the measurements of the set of measurement RSs 810 at 811, the at least one channel characteristic value for at least one of the prediction resources (e.g., at least one spatial-domain resource and corresponding frequency-domain resources such as the narrow beams 461-469 or 561-569 and associated (virtual) frequency domain occupation 475, 575, 760, 770, 780, and/or 790; the PRBs or REs associated with the (virtual) frequency domain occupation via the NZP-CSI-RS-Resource IE 610 (or the related IEs and/or fields, e.g., CSI-RS-ResourceMapping IE 620, CSI-FrequencyOccupation IE 630, startingRB field 631, nrofRBs field 632, and/or density field 640); or (virtual and/or prediction) frequency domain occupation determined at 808). The prediction at 814, in some aspects, may be based on an AI/ML (or other prediction) model as described in relation to FIG. 4 and may further be based on the one or more EPRE offsets (e.g., configured via powerControlOffset field 650 and/or powerControlOffsetSS field 660 or previously defined and/or configured).

At 1008, the UE may indicate, to the network node, the at least one predicted channel characteristic value for at least one of the one or more frequency-domain resources and a corresponding at least one of the one or more spatial-domain resources. For example, 1008 may be performed by application processor(s) 1206, cellular baseband processor(s) 1224, and/or virtual frequency domain occupation determination component 198 of FIG. 12. In some aspects, the at least one predicted channel characteristic value associated with the at least one channel characteristic prediction for first frequency-domain resources of the one or more frequency-domain resources associated with a first spatial-domain resource of the one or more spatial-domain resources includes at least one of a predicted L1-RSRP that is based on a linear average of a predicted RSRP for at least one RE associated with the first frequency-domain resources, a predicted L1-SINR that is based on a linear average of a predicted SINR for the at least one RE associated with the first frequency-domain resources, or a CQI associated with the first spatial-domain resource. For example, referring to FIGS. 4-8, the UE 804 may transmit the set of predicted values 816. In some aspects, the set of predicted values 816 may include at least one predicted channel characteristic value for at least one of the prediction resources (e.g., at least one spatial-domain resource and corresponding frequency-domain resources such as the narrow beams 461-469 or 561-569 and associated (virtual) frequency domain occupation 475, 575, 760, 770, 780, and/or 790; the PRBs or REs associated with the (virtual) frequency domain occupation via the NZP-CSI-RS-Resource IE 610 (or the related IEs and/or fields, e.g., CSI-RS-ResourceMapping IE 620, CSI-FrequencyOccupation IE 630, startingRB field 631, nrofRBs field 632, and/or density field 640); or (virtual and/or prediction) frequency domain occupation determined at 808).

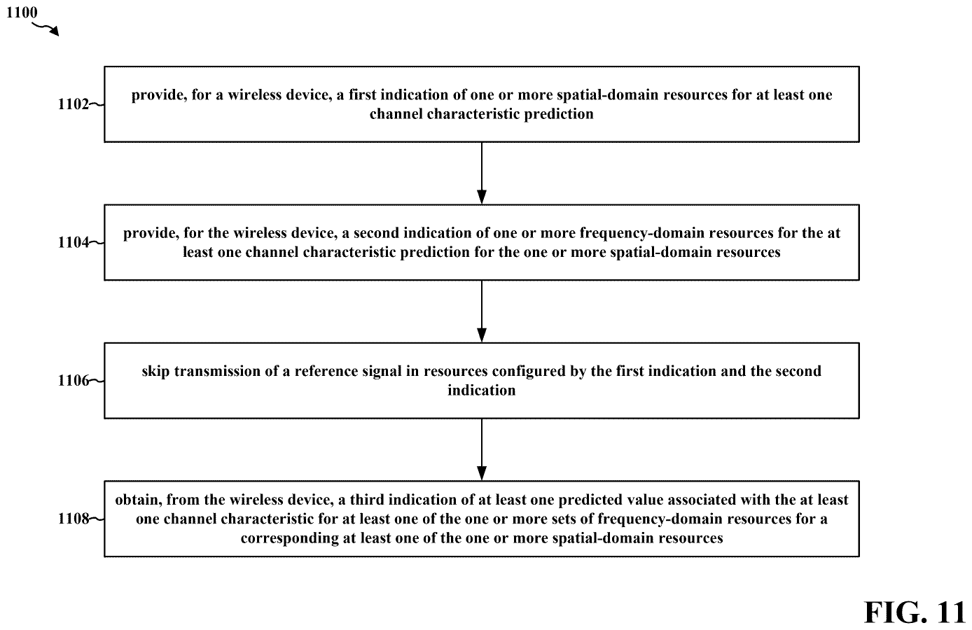

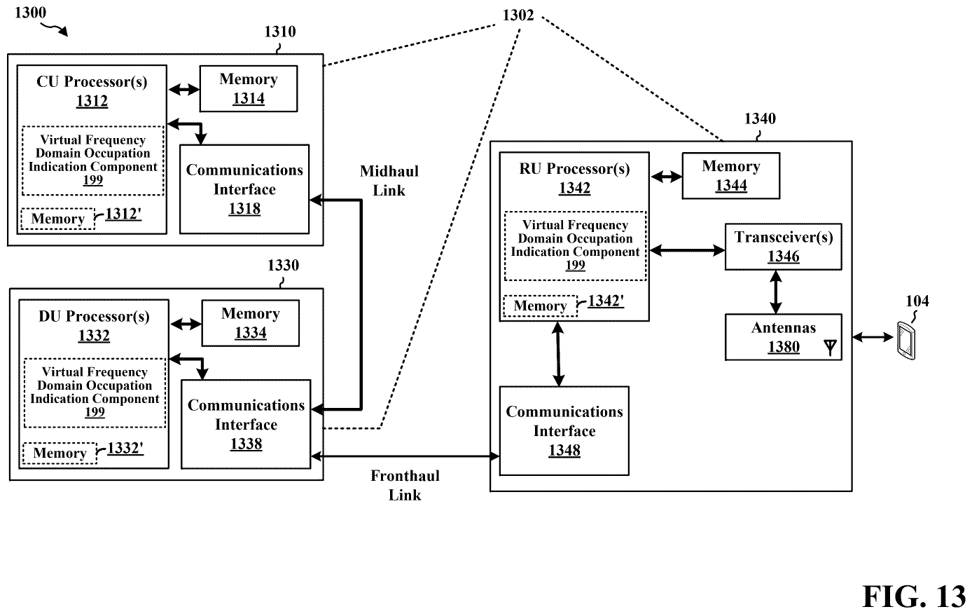

FIG. 11 is a flowchart 1100 of a method of wireless communication. The method may be performed by a network node, network device, or network entity such as a base station (e.g., the base station 102, 402, 502, 802; the network entity 1202, 1302). At 1102, the base station may provide, for a wireless device, a first indication of one or more spatial-domain resources for at least one channel characteristic prediction. For example, 1102 may be performed by CU processor(s) 1312, DU processor(s) 1332, RU processor(s) 1342, transceiver(s) 1346, antenna(s) 1380, and/or virtual frequency domain occupation indication component 199 of FIG. 13. In some aspects, the first indication may be included in a CSI report setting configuration for prediction resources, a CMR configuration associated with the CSI report setting configuration for the prediction resources, or a CPR configuration associated with the CSI report setting configuration for the prediction resources. For example, referring to FIGS. 4, 5, 7, and 8, the base station 402, 502, or 802 may transmit an indication of the one or more indications 806 identifying the (virtual and/or prediction) spatial domain resources (e.g., narrow beams 461-469 or narrow beams 561-569).

At 1104, the base station may provide, for the wireless device, a second indication of one or more frequency-domain resources for the at least one channel characteristic prediction for the one or more spatial-domain resources. For example, 1104 may be performed by CU processor(s) 1312, DU processor(s) 1332, RU processor(s) 1342, transceiver(s) 1346, antenna(s) 1380, and/or virtual frequency domain occupation indication component 199 of FIG. 13. The one or more frequency-domain resources, in some aspects, may be one or more sets of frequency-domain resources with each frequency-domain resource or set of frequency-domain resources corresponding to a frequency domain occupation as discussed above. In some aspects, the one or more frequency-domain resources may include different frequency-domain resources corresponding to different spatial-domain resources of the one or more spatial-domain resources such that predictions for different spatial-domain resources may be based on different frequency domain occupations. For example, referring to FIGS. 6 and 8, the base station 802 may transmit the second indication of one or more frequency-domain resources for the at least one channel characteristic prediction for the one or more spatial-domain resources in the one or more indications 806.

In some aspects, the second indication of the one or more frequency-domain resources may indicate a frequency domain occupation based on (or including) at least one of: a first set of contiguous PRBs in an active BWP, a second set of non-contiguous PRBs in the active BWP, each PRB within the active BWP, or a third set of PRBs spanning a frequency range that is greater than the active BWP. The one or more frequency-domain resources, in some aspects, may include multiple (different and/or independent) sets of contiguous PRBs in the active BWP or multiple (different and/or independent) sets of non-contiguous PRBs in the active BWP. The multiple (different and/or independent) sets of contiguous PRBs in the active BWP or the multiple (different and/or independent) sets of non-contiguous PRBs in the active BWP, in some aspects, may correspond to different spatial-domain (prediction and/or virtual) resources. In some aspects, the second indication of the one or more frequency-domain resources may indicate a frequency domain occupation based on (or including) a subset of REs of one or more PRBs. The second indication, in some aspects, may further indicate at least one EPRE offset relative to a corresponding at least one of an SS (e.g., an SSB or SSS) EPRE, a transmitted NZP-CSI-RS EPRE, a PDSCH EPRE, or a DMRS EPRE, and the at least one channel characteristic prediction may be based on the EPRE offset. For example, referring to FIGS. 4-8, the second indication of the one or more indications 806 may indicate the (virtual) frequency domain occupation 475, 575, 760, 770, 780, and/or 790; the PRBs or REs associated with the (virtual) frequency domain occupation via the NZP-CSI-RS-Resource IE 610 (or the related IEs and/or fields, e.g., CSI-RS-ResourceMapping IE 620, CSI-FrequencyOccupation IE 630, startingRB field 631, nrofRBs field 632, and/or density field 640); and/or one or more EPRE offsets (e.g., via powerControlOffset field 650, and powerControlOffsetSS field 660).

The second indication of the one or more frequency-domain resources, in some aspects, may be based on an explicit indication. For example, in some aspects, the second indication may be included in at least one NZP-CSI-RS resource configuration (e.g., an NZP-CSI-RS-Resource IE). In some aspects, each NZP-CSI-RS resource configuration (e.g., NZP-CSI-RS-Resource IE) of the at least one NZP-CSI-RS resource configuration(s) indicates a starting PRB and a number of PRBs for corresponding frequency-domain resources of the one or more frequency-domain resources. The corresponding frequency-domain resources, in some aspects, may include PRBs outside an active BWP based on the starting PRB and the number of PRBs indicated for at least the corresponding frequency-domain resources. The at least one EPRE offset, in some aspects, may be included in at least one of a power control offset configuration (e.g., a powerControlOffset IE) or a power control offset SS configuration (e.g., a powercontrolOffsetSS IE), and the at least one of the power control offset configuration or the power control offset SS configuration may be included in an NZP-CSI-RS resource configuration (e.g., NZP-CSI-RS-Resource IE). For example, the power control offset configuration (e.g., a powerControlOffset IE), in some aspects, may be used to configure an EPRE offset associated with a prediction resource and a PDSCH EPRE when predicting and/or determining a CQI while a power control offset SS configuration (e.g., a powercontrolOffsetSS IE) may be used to configure an EPRE offset associated with the prediction resource and an SS (e.g., SSB or SSS) EPRE or some other CSI-RS's EPRE when predicting and/or determining L1-RSRPs (or L1-SINRs). In some aspects, first frequency-domain resources of the one or more frequency-domain resources may include a subset of non-contiguous PRBs in an active BWP, and the second indication may indicate the subset of non-contiguous PRBs in the active BWP by indicating one of an even PRB occupation or an odd PRB occupation via a density configuration (e.g., a density field) included in a CSI-RS resource mapping configuration (e.g., a CSI-RS-ResourceMapping IE) that is in turn included in the NZP-CSI-RS resource configuration (e.g., the NZP-CSI-RS-Resource IE). A subset of REs of one or more PRBs, in some aspects, may be indicated via the density configuration (e.g., a density field) included in a CSI-RS resource mapping configuration (e.g., a CSI-RS-ResourceMapping IE) that is in turn included in the NZP-CSI-RS resource configuration (e.g., the NZP-CSI-RS-Resource IE). For example, referring to FIGS. 4-6 and 8, the second indication of the one or more indications 806 may indicate the (virtual) frequency domain occupation 475 or 575; the PRBs or REs associated with the (virtual) frequency domain occupation via the NZP-CSI-RS-Resource IE 610 (or the related IEs and/or fields, e.g., CSI-RS-ResourceMapping IE 620, CSI-FrequencyOccupation IE 630, startingRB field 631, nrofRBs field 632, and/or density field 640); and/or at least one EPRE offsets (e.g., via powerControlOffset field 650, and powerControlOffsetSS field 660).

The second indication of the one or more frequency-domain resources, in some aspects, may be an indication of one or more frequency-domain measurement resources having a defined correspondence to the one or more frequency-domain (virtual and/or prediction) resources. The correspondence, in some aspects, may be defined in one of a standard such that the wireless device is pre-configured with (an indication of) the defined correspondence (or a plurality of selectable defined correspondences) or in a configuration message (e.g., an RRC message) providing the defined correspondence (or indicating a selected defined correspondence from the plurality of selectable defined correspondences). In some aspects, the defined correspondence may be based on (e.g., a reference set of frequency-domain resources may be defined based on) one of a union or intersection of the one or more frequency-domain measurement resources. The defined correspondence, in some aspects, may include a correspondence between the one or more frequency-domain (virtual and/or prediction) resources and a reference set of frequency-domain resources based on a scaling factor applied to one of a union of the one or more frequency-domain measurement resources or an intersection of the one or more frequency-domain measurement resources. In some aspects, based on the one or more frequency-domain measurement resources, the base station and the wireless device may determine one of a union or intersection of the one or more frequency-domain measurement resources (e.g., frequency-domain resources that may be used as reference frequency-domain resources) and may then apply a scaling factor (e.g., 0<s≤sₘₐₓ, where sₘₐₓ may be greater than, or equal to, 1) to determine, generate, and/or identify a reference set of frequency-domain resources (or a reference frequency domain occupation) corresponding to the one or more frequency-domain (virtual and/or prediction) resources. In some aspects, the identified one or more frequency-domain (virtual and/or prediction) resources may be applied to, or used for, the prediction resources (e.g., may be associated with, or applied to, each of the spatial-domain (virtual and/or prediction) resources). In some aspects, the wireless device may be configured (e.g., the base station may configure the wireless device) with at least one defined EPRE offset relative to, or from, a corresponding at least one of an SS (e.g., an SSB or SSS) EPRE, a transmitted NZP-CSI-RS EPRE, a PDSCH EPRE, or a DMRS EPRE. For example, an EPRE offset associated with a prediction resource, in some aspects, may be defined for a PDSCH EPRE and may be used when predicting and/or determining a CQI while an EPRE offset associated with a prediction resource, in some aspects, may be defined for an SS (e.g., SSB or SSS) EPRE or some other CSI-RS's EPRE (e.g., RSs associated with the one or more frequency-domain measurement resources) when predicting and/or determining L1-RSRPs (or L1-SINRs). For example, referring to FIGS. 4, 5, 7, and 8, the second indication of the one or more indications 806 may indicate the measurement resources (the wide beams 41-413 and 511-513, or the beam 711-713 and the corresponding frequency domain occupations 425, 525, or 731-733) and the UE 804 (and the base station 802) may determine, at 808, the (virtual and/or prediction) frequency-domain resources (or frequency domain occupation) associated with the prediction resources based on a defined correspondence between the indicated measurement resources and the (virtual and/or prediction) frequency-domain resources (or frequency domain occupation) as described in relation to FIG. 7.

At 1106, the base station may refrain from transmitting (and the wireless device may not receive) a RS (e.g., an actual RS) via the one or more frequency-domain resources for the at least one channel characteristic prediction for the one or more spatial-domain resources. For example, 1106 may be performed by CU processor(s) 1312, DU processor(s) 1332, RU processor(s) 1342, transceiver(s) 1346, antenna(s) 1380, and/or virtual frequency domain occupation indication component 199 of FIG. 13. The base station, in some aspects, may transmit a set of RSs associated with a set of CMRs and/or IMRs for the wireless device to measure. Referring to FIGS. 4, 5, 7, and 8, for example, the base station 802 may transmit the set of measurement RSs 810 (e.g., via the measurement resources indicated in one of the one or more indications 806 such as the wide beams 41-413 and 511-513, or the beam 711-713 and the corresponding frequency domain occupations 425, 525, or 731-733) and may, at 812, skip transmission of (or refrain from transmitting) RSs via the REs associated with the prediction resources (e.g., via the indicated frequency-domain resources for the one or more spatial-domain resources).

The wireless device may predict at least one channel characteristic value based on resources indicated in the first indication and the second indication. For example, 1106 may be performed by application processor(s) 1206, cellular baseband processor(s) 1224, and/or virtual frequency domain occupation determination component 198 of FIG. 12. As discussed above, predicting the at least one channel characteristic, in some aspects, may include using the at least one defined EPRE offset. In some aspects, predicting the at least one channel characteristic may include using an indicated EPRE offset. For example, referring to FIGS. 4-8, the UE 804 may, at 814, predict, based on the measurements of the set of measurement RSs 810, the at least one channel characteristic value for at least one of the prediction resources (e.g., at least one spatial-domain resource and corresponding frequency-domain resources such as the narrow beams 461-469 or 561-569 and associated (virtual) frequency domain occupation 475, 575, 760, 770, 780, and/or 790; the PRBs or REs associated with the (virtual) frequency domain occupation via the NZP-CSI-RS-Resource IE 610 (or the related IEs and/or fields, e.g., CSI-RS-ResourceMapping IE 620, CSI-FrequencyOccupation IE 630, startingRB field 631, nrofRBs field 632, and/or density field 640); or (virtual and/or prediction) frequency domain occupation determined at 808). The prediction at 814, in some aspects, may be based on an AI/ML (or other prediction) model as described in relation to FIG. 4 and may further be based on the one or more EPRE offsets (e.g., configured via powerControlOffset field 650 and/or powerControlOffsetSS field 660 or previously defined and/or configured).

At 1108, the base station may obtain, from the wireless device, the at least one predicted channel characteristic value for at least one of the one or more frequency-domain resources and a corresponding at least one of the one or more spatial-domain resources. For example, 1108 may be performed by CU processor(s) 1312, DU processor(s) 1332, RU processor(s) 1342, transceiver(s) 1346, antenna(s) 1380, and/or virtual frequency domain occupation indication component 199 of FIG. 13. In some aspects, the at least one predicted channel characteristic value associated with the at least one channel characteristic prediction for first frequency-domain resources of the one or more frequency-domain resources associated with a first spatial-domain resource of the one or more spatial-domain resources includes at least one of a predicted L1-RSRP that is based on a linear average of a predicted RSRP for at least one RE associated with the first frequency-domain resources, a predicted L1-SINR that is based on a linear average of a predicted SINR for the at least one RE associated with the first frequency-domain resources, or a CQI associated with the first spatial-domain resource. As discussed above, the at least one predicted channel characteristic, in some aspects, may be based on the at least one defined EPRE offset. In some aspects, the at least one predicted channel characteristic may be based on an indicated EPRE offset. For example, referring to FIGS. 4-8, the base station 802 may receive the set of predicted values 816. In some aspects, the set of predicted values 816 may include at least one predicted channel characteristic value for at least one of the prediction resources (e.g., at least one spatial-domain resource and corresponding frequency-domain resources such as the narrow beams 461-469 or 561-569 and associated (virtual) frequency domain occupation 475, 575, 760, 770, 780, and/or 790; the PRBs or REs associated with the (virtual) frequency domain occupation via the NZP-CSI-RS-Resource IE 610 (or the related IEs and/or fields, e.g., CSI-RS-ResourceMapping IE 620, CSI-FrequencyOccupation IE 630, startingRB field 631, nrofRBs field 632, and/or density field 640); or (virtual and/or prediction) frequency domain occupation determined at 808).

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include at least one cellular baseband processor 1224 (also referred to as a modem) coupled to one or more transceivers 1222 (e.g., cellular RF transceiver). The cellular baseband processor(s) 1224 may include at least one on-chip memory 1224′. In some aspects, the apparatus 1204 may further include one or more subscriber identity modules (SIM) cards 1220 and at least one application processor 1206 coupled to a secure digital (SD) card 1208 and a screen 1210. The application processor(s) 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize one or more antennas 1280 for communication. The cellular baseband processor(s) 1224 communicates through the transceiver(s) 1222 via the one or more antennas 1280 with the UE 104 and/or with an RU associated with a network entity 1202. The cellular baseband processor(s) 1224 and the application processor(s) 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor(s) 1224 and the application processor(s) 1206 are each responsible for general processing, including the execution of software stored on the computer-readable medium/memory. The software, when executed by the cellular baseband processor(s) 1224/application processor(s) 1206, causes the cellular baseband processor(s) 1224/application processor(s) 1206 to perform the various functions described supra. The computer-readable medium/memory may also be used for storing data that is manipulated by the cellular baseband processor(s) 1224/application processor(s) 1206 when executing software. The cellular baseband processor(s) 1224/application processor(s) 1206 may be a component of the UE 350 and may include the at least one memory 360 and/or at least one of the TX processor 368, the RX processor 356, and the controller/processor 359. In one configuration, the apparatus 1204 may be at least one processor chip (modem and/or application) and include just the cellular baseband processor(s) 1224 and/or the application processor(s) 1206, and in another configuration, the apparatus 1204 may be the entire UE (e.g., see UE 350 of FIG. 3) and include the additional modules of the apparatus 1204.

As discussed supra, the virtual frequency domain occupation determination component 198 may be configured to receive, from a network node, a first indication of one or more resources for at least one channel characteristic prediction, receive, from the network node, a second indication of one or more frequency occupations for the at least one channel characteristic prediction for the one or more resources for which the network node refrains from transmitting a reference signal, and indicate, to the network node, at least one predicted channel characteristic value for at least one of the one or more frequency occupations and a corresponding at least one of the one or more resources. The virtual frequency domain occupation determination component 198 may be within the cellular baseband processor(s) 1224, the application processor(s) 1206, or both the cellular baseband processor(s) 1224 and the application processor(s) 1206. The virtual frequency domain occupation determination component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1204 may include a variety of components configured for various functions. In one configuration, the apparatus 1204, and in particular the cellular baseband processor(s) 1224 and/or the application processor(s) 1206, may include means for receiving, from a network node, a first indication of one or more resources for at least one channel characteristic prediction. The apparatus 1204, and in particular the cellular baseband processor(s) 1224 and/or the application processor(s) 1206, may include means for receiving, from the network node, a second indication of one or more frequency occupations for the at least one channel characteristic prediction for the one or more resources for which the network node refrains from transmitting a reference signal. The apparatus 1204, and in particular the cellular baseband processor(s) 1224 and/or the application processor(s) 1206, may include means for indicating, to the network node, at least one predicted channel characteristic value for at least one of the one or more frequency occupations and a corresponding at least one of the one or more resources. The apparatus 1204, and in particular the cellular baseband processor(s) 1224 and/or the application processor(s) 1206, may include means for predicting at least one channel characteristic based on resources indicated in the first indication and the second indication. The means may be the virtual frequency domain occupation determination component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means or as described in relation to FIGS. 9 and 10.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, one or more antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the virtual frequency domain occupation indication component 199 may be configured to provide, for a wireless device, a first indication of one or more resources for at least one channel characteristic prediction, provide, for the wireless device, a second indication of one or more frequency occupations for the at least one channel characteristic prediction for the one or more resources, skip transmission of a reference signal in resources configured by the first indication and the second indication, and obtain, from the wireless device, a third indication of at least one predicted channel characteristic value for at least one of the one or more frequency occupations and a corresponding at least one of the one or more resources. The virtual frequency domain occupation indication component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for providing, for a wireless device, a first indication of one or more resources for at least one channel characteristic prediction. In one configuration, the network entity 1302 may include means for providing, for the wireless device, a second indication of one or more frequency occupations for the at least one channel characteristic prediction for the one or more resources. In one configuration, the network entity 1302 may include means for skipping transmission of a reference signal in resources configured by the first indication and the second indication. In one configuration, the network entity 1302 may include means for obtaining, from the wireless device, a third indication of at least one predicted value associated with the at least one channel characteristic prediction for at least one of the one or more frequency occupations and a corresponding at least one of the one or more resources. The means may be the virtual frequency domain occupation indication component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIG. 11.

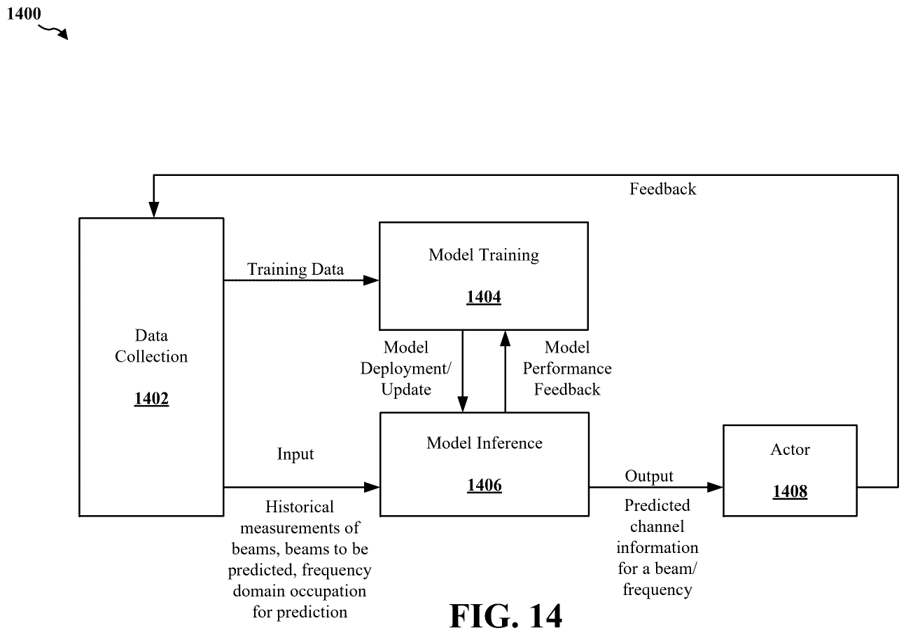

FIG. 14 is a diagram 1400 illustrating an AI/ML algorithm for wireless communication and that illustrates various aspects model training, model inference, model feedback, and model update. The AI/ML algorithm may include various functions including a data collection function 1402, a model training function 1404, a model inference function 1406, and an actor function 1408. Various aspects described in connection with FIG. 14 may be performed by one or more entities in a wireless communication system. As an example, in some aspects, the data collection, model training, model inference, and action based on the model inference may occur at a UE. In other aspects, the data collection, model training, model inference, and action based on the model inference may occur at the network. In other aspects, the data collection may occur at the UE and may be provided to the network, which performs the model training and/or model inference. In some aspects, the output may be used at the network or may be provided to a UE, which may perform an action based on the output. In other aspects, the data collection may be performed at the network and may be provided to a UE, which may perform the model training and/or model inference. In some aspects, the UE may use the output to perform an action or may provide the output to the network. These are non-limiting examples to illustrate the concept that one or more of the functions described in connection with FIG. 14 may be performed by a UE and/or a network node. As described herein, a UE may use the model inference function 1406 to obtain a predicted information for one or more beams and for a virtual frequency domain allocation. In some aspects, the actor associated with actor function 1408 may be a UE that reports at least some of the predicted information to a network. The input for the prediction may include historical measurement information for other beams or other frequency occupations.

The data collection function 1402 may be a function that provides input data to the model training function 1404 and the model inference function 1406. The data collection function 1402 may include any form of data preparation, and it may not be specific to the implementation of the AI/ML algorithm (e.g., data pre-processing and cleaning, formatting, and transformation).

Examples of input data may include, but are not limited to, measurements, such as RSRP measurements, channel measurements, or other uplink/downlink transmissions, from entities including UEs or network nodes, feedback from the actor function 1408 (e.g., which may be a UE or network node), output from another AI/ML model, etc. The data collection function 1402 may include training data, which refers to the data to be sent as the input for the model training function 1404, and inference data, which refers to be sent as the input for the model inference function 1406.

The model training function 1404 may be a function that performs the ML model training, validation, and testing, which may generate model performance metrics as part of the model testing procedure. The model training function 1404 may also be responsible for data preparation (e.g., data pre-processing and cleaning, formatting, and transformation) based on the training data delivered or received from the data collection function 1402. The model training function 1404 may deploy or update a trained, validated, and tested AI/ML model to the model inference function 1406, and receive a model performance feedback from the model inference function 1406. As described above, there may be various functionalities to be performed by an AI/ML model for wireless communication.

The model inference function 1406 may be a function that provides an AI/ML model inference output (e.g., predictions or decisions). The model inference function 1406 may also perform data preparation (e.g., data pre-processing and cleaning, formatting, and transformation) based on the inference data delivered from the data collection function 1402. The output of the model inference function 1406 may include the inference output of the AI/ML model produced by the model inference function 1406. The details of the inference output may be use case specific. As an example, the output may include a beam prediction for beam management. The prediction may be for the network or may be for the UE. In some aspects, the actor function 1408 may be a component of the base station or of a core network. In other aspects, the actor function 1408 may be a UE in communication with a wireless network.

The model performance feedback may refer to information derived from the model inference function 1406 that may be suitable for the improvement of the AI/ML model trained in the model training function 1404. The feedback from the actor function 1408 or other network entities (via the data collection function 1402) may be implemented for the model inference function 1406 to create the model performance feedback.

The actor function 1408 may be a function that receives the output from the model inference function 1406 and triggers or performs corresponding actions. The actor function 1408 may trigger actions directed to network entities including the other network entities or itself. The actor function 1408 may also provide feedback information that the model training function 1404 or the model inference function 1406 to derive training or inference data or performance feedback. The feedback may be transmitted back to the data collection function 1402.

The network and/or a UE may use machine-learning algorithms, deep-learning algorithms, neural networks, reinforcement learning, regression, boosting, or advanced signal processing methods for aspects of wireless communication including the various functionalities such as beam management, CSF, or positioning, among other examples.

In some aspects described herein, the network and/or a UE may train one or more neural networks to learn the dependence of measured qualities on individual parameters. Among others, examples of machine learning models or neural networks that may be included in the network entity include artificial neural networks (ANN); decision tree learning; convolutional neural networks (CNNs); deep learning architectures in which an output of a first layer of neurons becomes an input to a second layer of neurons, and so forth; support vector machines (SVM), e.g., including a separating hyperplane (e.g., decision boundary) that categorizes data; regression analysis; Bayesian networks; genetic algorithms; deep convolutional networks (DCNs) configured with additional pooling and normalization layers; and deep belief networks (DBNs).

A machine learning model, such as an artificial neural network (ANN), may include an interconnected group of artificial neurons (e.g., neuron models), and may be a computational device or may represent a method to be performed by a computational device. The connections of the neuron models may be modeled as weights. Machine learning models may provide predictive modeling, adaptive control, and other applications through training via a dataset. The model may be adaptive based on external or internal information that is processed by the machine learning model. Machine learning may provide non-linear statistical data model or decision making and may model complex relationships between input data and output information.

A machine learning model may include multiple layers and/or operations that may be formed by the concatenation of one or more of the referenced operations. Examples of operations that may be involved include extraction of various features of data, convolution operations, fully connected operations that may be activated or deactivated, compression, decompression, quantization, flattening, etc. As used herein, a “layer” of a machine learning model may be used to denote an operation on input data. For example, a convolution layer, a fully connected layer, and/or the like may be used to refer to associated operations on data that is input into a layer. A convolution AxB operation refers to an operation that converts a number of input features A into a number of output features B. “Kernel size” may refer to a number of adjacent coefficients that are combined in a dimension. As used herein, “weight” may be used to denote one or more coefficients used in the operations in the layers for combining various rows and/or columns of input data. For example, a fully connected layer operation may have an output y that is determined based at least in part on a sum of a product of input matrix x and weights A (which may be a matrix) and bias values B (which may be a matrix). The term “weights” may be used herein to generically refer to both weights and bias values. Weights and biases are examples of parameters of a trained machine learning model. Different layers of a machine learning model may be trained separately.

Machine learning models may include a variety of connectivity patterns, e.g., any feed-forward networks, hierarchical layers, recurrent architectures, feedback connections, etc. The connections between layers of a neural network may be fully connected or locally connected. In a fully connected network, a neuron in a first layer may communicate its output to each neuron in a second layer, and each neuron in the second layer may receive input from every neuron in the first layer. In a locally connected network, a neuron in a first layer may be connected to a limited number of neurons in the second layer. In some aspects, a convolutional network may be locally connected and configured with shared connection strengths associated with the inputs for each neuron in the second layer. A locally connected layer of a network may be configured such that each neuron in a layer has the same, or similar, connectivity pattern, but with different connection strengths.

A machine learning model or neural network may be trained. For example, a machine learning model may be trained based on supervised learning. During training, the machine learning model may be presented with input that the model uses to compute to produce an output. The actual output may be compared to a target output, and the difference may be used to adjust parameters (such as weights and biases) of the machine learning model in order to provide an output closer to the target output. Before training, the output may be incorrect or less accurate, and an error, or difference, may be calculated between the actual output and the target output. The weights of the machine learning model may then be adjusted so that the output is more closely aligned with the target. To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error or to move the output closer to the target. This manner of adjusting the weights may be referred to as back propagation through the neural network. The process may continue until an achievable error rate stops decreasing or until the error rate has reached a target level.

The machine learning models may include computational complexity and substantial processing for training the machine learning model. An output of one node is connected as the input to another node. Connections between nodes may be referred to as edges, and weights may be applied to the connections/edges to adjust the output from one node that is applied as input to another node. Nodes may apply thresholds in order to determine whether, or when, to provide output to a connected node. The output of each node may be calculated as a non-linear function of a sum of the inputs to the node. The neural network may include any number of nodes and any type of connections between nodes. The neural network may include one or more hidden nodes. Nodes may be aggregated into layers, and different layers of the neural network may perform different kinds of transformations on the input. A signal may travel from an input at a first layer through the multiple layers of the neural network to an output at the last layer of the neural network and may traverse layers multiple times.

Various aspects relate generally to indicating a frequency-domain resource occupation (e.g., via a frequency occupation configuration as indicated in a CSI-FrequencyOccupation configuration or freqBand field) for a CSI report associated with reporting predicted values. Some aspects more specifically relate to indicating, from a network device to a wireless device via a first indication, one or more spatial-domain (prediction or virtual) resources for which to predict at least one channel characteristic and, via a second indication, one or more frequency-domain (prediction or virtual) resources for the at least one channel characteristic prediction for the one or more spatial-domain resources. Based on the indicated one or more spatial-domain resources and the one or more frequency-domain resources, a wireless device may report to the network device at least one predicted channel characteristic value for at least one of the one or more frequency-domain resources and a corresponding at least one of the one or more spatial-domain resources. In some aspects, the wireless device may predict at least one channel characteristic for the one or more frequency-domain resources and corresponding one or more spatial-domain resources without reception of a set of reference signals in resources configured for the at least one channel characteristic prediction.

Particular aspects of the subject matter described in this disclosure can be implemented to realize one or more of the following potential advantages. In some examples, by indicating one or more sets of frequency-domain resources associated with one or more spatial-domain resources, the described techniques can be used to facilitate predictive beam management and realize the reduced overhead, power consumption, and latency associated with predictive beam management.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, comprising: receiving, from a network node, a first indication of one or more resources for at least one channel characteristic prediction; receiving, from the network node, a second indication of one or more frequency occupations for the at least one channel characteristic prediction for the one or more resources for which the network node refrains from transmitting a reference signal; and indicating, to the network node, at least one predicted channel characteristic value for at least one of the one or more frequency occupations and a corresponding at least one of the one or more resources.

Aspect 2 is the method of aspect 1, wherein the at least one predicted channel characteristic value associated with the at least one channel characteristic prediction for a first frequency occupation of the one or more frequency occupations associated with a first spatial-domain resource of the one or more resources includes at least one of a predicted layer 1 reference signal received power (L1-RSRP) that is based on a linear average of a predicted RSRP for at least one resource element (RE) associated with the first frequency occupation, a predicted layer 1 signal to interference and noise ratio (L1-SINR) that is based on a linear average of a predicted SINR for the at least one RE associated with the first frequency occupation, or a channel quality indicator (CQI) associated with the first spatial-domain resource.

Aspect 3 is the method of any of aspects 1 and 2, wherein the one or more frequency occupations indicate frequency-domain resources based on at least one of: a first set of contiguous physical resource blocks (PRBs) in an active bandwidth part (BWP), a second set of non-contiguous PRBs in the active BWP, each PRB within the active BWP, or a third set of PRBs spanning a frequency range that is greater than the active BWP.

Aspect 4 is the method of aspect 3, wherein the one or more frequency occupations comprise multiple sets of contiguous PRBs in the active BWP or multiple sets of non-contiguous PRBs in the active BWP.

Aspect 5 is the method of any of aspects 1 to 4, wherein the at least one channel characteristic prediction is based on at least one energy per resource element (EPRE) offset relative to a corresponding at least one of a synchronization signal block (SSB) EPRE, a transmitted non-zero power channel state information reference signal (NZP-CSI-RS) EPRE, a physical downlink shared channel (PDSCH) EPRE, or a demodulation reference signal (DMRS) EPRE.

Aspect 6 is the method of aspect 5, wherein the at least one EPRE offset is comprised in at least one of a power control offset configuration or a power control offset synchronization signal (SS) configuration, wherein the at least one of the power control offset configuration or the power control offset SS configuration is comprised in a non-zero-power (NZP) channel state information (CSI) reference signal (RS) resource (NZP-CSI-RS-Resource) configurations.

Aspect 7 is the method of any of aspects 1 to 6, wherein the one or more frequency occupations indicate frequency-domain resources based on a subset of resource elements (REs) of one or more physical resource blocks (PRBs).

Aspect 8 is the method of aspect 7, wherein the subset of REs is indicated via a density configuration comprised in a channel state information reference signal (CSI-RS) resource mapping configuration, the CSI-RS resource mapping being comprised in a non-zero-power (NZP) CSI-RS resource (NZP-CSI-RS-Resource) configuration.

Aspect 9 is the method of any of aspects 1 to 8, wherein the second indication is comprised in at least one non-zero-power (NZP) channel state information (CSI) reference signal (RS) resource (NZP-CSI-RS-Resource) configuration.

Aspect 10 is the method of aspect 9, wherein each NZP-CSI-RS-Resource configuration of the at least one NZP-CSI-RS-Resource configuration indicates a starting physical resource block (PRB) and a number of PRBs for corresponding frequency occupations of the one or more frequency occupations.

Aspect 11 is the method of aspect 10, wherein, based on the starting PRB and the number of PRBs indicated for at least the corresponding frequency occupations of the one or more frequency occupations, the corresponding frequency occupations comprise PRBs outside an active bandwidth part (BWP).

Aspect 12 is the method of any of aspects 1 to 11, wherein a first frequency occupation of the one or more frequency occupations comprises a subset of non-contiguous physical resource blocks (PRBs) in an active bandwidth part (BWP), wherein the second indication indicates the subset of non-contiguous PRBs in the active BWP by indicating one of an even PRB occupation or an odd PRB occupation via a density configuration comprised in a channel state information reference signal (CSI-RS) resource mapping configuration that is in turn comprised in a non-zero-power (NZP) CSI-RS resource (NZP-CSI-RS-Resource) configuration.

Aspect 13 is the method of any of aspects 1 to 5 and 7, wherein the second indication comprises an indication of one or more measurement resource frequency occupations having a defined correspondence to the one or more frequency occupations.

Aspect 14 is the method of aspect 13, wherein the defined correspondence comprises a correspondence between the one or more frequency occupations and a reference set of frequency-domain resources based on a scaling factor applied to one of a union of the one or more measurement resource frequency occupations or an intersection of the one or more measurement resource frequency occupations.

Aspect 15 is the method of any of aspects 1 to 14, further comprising: predicting at least one channel characteristic value based on resources indicated in the first indication and the second indication.

Aspect 16 is the method of aspect 15, wherein predicting the at least one channel characteristic using at least one defined energy per resource element (EPRE) offset from a corresponding at least one of a synchronization signal block (SSB) EPRE, a transmitted non-zero power channel state information reference signal (NZP-CSI-RS) EPRE, a physical downlink shared channel (PDSCH) EPRE, or a demodulation reference signal (DMRS) EPRE.

Aspect 17 is a method of wireless communication at a network node, comprising: providing, for a wireless device, a first indication of one or more resources for at least one channel characteristic prediction; providing, for the wireless device, a second indication of one or more frequency occupations for the at least one channel characteristic prediction for the one or more resources; skipping transmission of a reference signal in resources configured by the first indication and the second indication; and obtaining, from the wireless device, a third indication of at least one predicted channel characteristic value for at least one of the one or more frequency occupations and a corresponding at least one of the one or more resources.

Aspect 18 is the method of aspect 17, wherein the at least one predicted channel characteristic value associated with the at least one channel characteristic prediction for a first frequency occupation of the one or more frequency occupations associated with a first spatial-domain resource of the one or more resources includes at least one of a predicted layer 1 reference signal received power (L1-RSRP) that is based on a linear average of a predicted RSRP for at least one resource element (RE) associated with the first frequency occupation, a predicted layer 1 signal to interference and noise ratio (L1-SINR) that is based on a linear average of a predicted SINR for the at least one RE associated with the first frequency occupation, or a channel quality indicator (CQI) associated with the first spatial-domain resource.

Aspect 19 is the method of any of aspects 17 and 18, wherein the one or more frequency occupations indicate frequency-domain resources based on at least one of: a first set of contiguous physical resource blocks (PRBs) in an active bandwidth part (BWP), a second set of non-contiguous PRBs in the active BWP, each PRB within the active BWP, or a third set of PRBs spanning a frequency range that is greater than the active BWP.

Aspect 20 is the method of aspect 19, wherein the one or more frequency occupations comprise multiple sets of contiguous PRBs in the active BWP or multiple sets of non-contiguous PRBs in the active BWP.

Aspect 21 is the method of any of aspects 17 to 20, wherein the at least one channel characteristic prediction is based on at least one energy per resource element (EPRE) offset relative to a corresponding at least one of a synchronization signal block (SSB) EPRE, a transmitted non-zero power channel state information reference signal (NZP-CSI-RS) EPRE, a physical downlink shared channel (PDSCH) EPRE, or a demodulation reference signal (DMRS) EPRE.

Aspect 22 is the method of aspect 21, wherein the at least one EPRE offset is comprised in at least one of a power control offset configuration or a power control offset synchronization signal (SS) configuration, wherein the at least one of the power control offset configuration or the power control offset SS configuration is comprised in a non-zero-power (NZP) channel state information (CSI) reference signal (RS) resource (NZP-CSI-RS-Resource) configurations.

Aspect 23 is the method of any of aspects 17 to 21, wherein the at least one EPRE offset is a defined at least one EPRE offset.

Aspect 24 is the method of any of aspects 17 to 23, wherein the one or more frequency occupations indicate frequency-domain resources based on a subset of resource elements (REs) of one or more physical resource blocks (PRBs).

Aspect 25 is the method of aspect 17 to 24, wherein the subset of REs is indicated via a density configuration comprised in a channel state information reference signal (CSI-RS) resource mapping configuration, the CSI-RS resource mapping being comprised in a non-zero-power (NZP) CSI-RS resource (NZP-CSI-RS-Resource) configuration.

Aspect 26 is the method of aspect is the method of any of aspects 17 to 25, wherein the second indication is comprised in at least one non-zero-power (NZP) channel state information (CSI) reference signal (RS) resource (NZP-CSI-RS-Resource) configuration.

Aspect 27 is the method of aspect 26, wherein each NZP-CSI-RS-Resource configuration of the at least one NZP-CSI-RS-Resource configuration indicates a starting physical resource block (PRB) and a number of PRBs for corresponding frequency occupations of the one or more frequency occupations.

Aspect 28 is the method of aspect 27, wherein, based on the starting PRB and the number of PRBs indicated for at least the corresponding frequency occupations of the one or more frequency occupations, the corresponding frequency occupations comprise PRBs outside an active bandwidth part (BWP).

Aspect 29 is the method of any of aspects 17 to 28, wherein a first frequency occupation of the one or more frequency occupations comprises a subset of non-contiguous physical resource blocks (PRBs) in an active bandwidth part (BWP), wherein the second indication indicates the subset of non-contiguous PRBs in the active BWP by indicating one of an even PRB occupation or an odd PRB occupation via a density configuration comprised in a channel state information reference signal (CSI-RS) resource mapping configuration that is in turn comprised in a non-zero-power (NZP) CSI-RS resource (NZP-CSI-RS-Resource) configuration.

Aspect 30 is the method of any of aspects 17 to 21, 23, and 24, wherein the second indication comprises an indication of one or more measurement resource frequency occupations having a defined correspondence to the one or more frequency occupations.

Aspect 31 is the method of aspect 30, wherein the defined correspondence comprises a correspondence between the one or more frequency occupations and a reference set of frequency-domain resources based on a scaling factor applied to one of a union of the one or more measurement resource frequency occupations or an intersection of the one or more measurement resource frequency occupations.

Aspect 32 is the method of any of aspects 1-31, wherein the one or more resources is associated with at least one of a spatial-domain resource, a beam, or a spatial transmission filter.

Aspect 33 is an apparatus for wireless communication at a device including at least one memory and at least one processor coupled to the at least one memory and, based at least in part on information stored in the memory, the at least one processor is configured, individually or in any combination, to implement any of aspects 1 to 16.

Aspect 34 is the apparatus of aspect 33, further including a transceiver or an antenna coupled to the at least one processor.

Aspect 35 is an apparatus for wireless communication at a device including means for implementing any of aspects 1 to 16.

Aspect 36 is a computer-readable medium (e.g., a non-transitory computer-readable medium) storing computer executable code, where the code when executed by a processor causes the processor to implement any of aspects 1 to 16.

Aspect 37 is an apparatus for wireless communication at a device including at least one memory and at least one processor coupled to the at least one memory and, based at least in part on information stored in the memory, the at least one processor is configured, individually or in any combination, to implement any of aspects 17 to 32.

Aspect 38 is the apparatus of aspect 37, further including a transceiver or an antenna coupled to the at least one processor.

Aspect 39 is an apparatus for wireless communication at a device including means for implementing any of aspects 17 to 32.

Aspect 40 is a computer-readable medium (e.g., a non-transitory computer-readable medium) storing computer executable code, where the code when executed by a processor causes the processor to implement any of aspects 17 to 32.

1. An apparatus for wireless communication at a wireless device, comprising:
at least one memory; and
at least one processor coupled to the at least one memory and, based at least in part on information stored in the at least one memory, the at least one processor, individually or in any combination, is configured to:
receive, from a network node, a first indication of one or more resources for at least one channel characteristic prediction;
receive, from the network node, a second indication of one or more frequency occupations for the at least one channel characteristic prediction for the one or more resources for which the network node refrains from transmitting a reference signal; and
indicate, to the network node, at least one predicted channel characteristic value for at least one of the one or more frequency occupations and a corresponding at least one of the one or more resources.

2. The apparatus of claim 1, wherein the at least one predicted channel characteristic value associated with the at least one channel characteristic prediction for a first frequency occupation of the one or more frequency occupations associated with a first spatial-domain resource of the one or more resources includes at least one of a predicted layer 1 reference signal received power (L1-RSRP) that is based on a linear average of a predicted RSRP for at least one resource element (RE) associated with the first frequency occupation, a predicted layer 1 signal to interference and noise ratio (L1-SINR) that is based on a linear average of a predicted SINR for the at least one RE associated with the first frequency occupation, or a channel quality indicator (CQI) associated with the first spatial-domain resource.

3. The apparatus of claim 1, wherein the one or more frequency occupations indicate frequency-domain resources associated with the one or more resources based on at least one of:
a first set of contiguous physical resource blocks (PRBs) in an active bandwidth part (BWP),
a second set of non-contiguous PRBs in the active BWP,
each PRB within the active BWP, or
a third set of PRBs spanning a frequency range that is greater than the active BWP.

4. The apparatus of claim 3, wherein the one or more frequency occupations comprise multiple sets of contiguous PRBs in the active BWP or multiple sets of non-contiguous PRBs in the active BWP.

5. The apparatus of claim 1, wherein the at least one channel characteristic prediction is based on at least one energy per resource element (EPRE) offset relative to a corresponding at least one of a synchronization signal block (SSB) EPRE, a transmitted non-zero power channel state information reference signal (NZP-CSI-RS) EPRE, a physical downlink shared channel (PDSCH) EPRE, or a demodulation reference signal (DMRS) EPRE.

6. The apparatus of claim 5, wherein the at least one EPRE offset is comprised in at least one of a power control offset configuration or a power control offset synchronization signal (SS) configuration, wherein the at least one of the power control offset configuration or the power control offset SS configuration is comprised in a non-zero-power (NZP) channel state information (CSI) reference signal (RS) resource (NZP-CSI-RS-Resource) configurations.

7. The apparatus of claim 1, wherein the one or more frequency occupations indicate frequency-domain resources based on a subset of resource elements (REs) of one or more physical resource blocks (PRBs).

8. The apparatus of claim 7, wherein the subset of REs is indicated via a density configuration comprised in a channel state information reference signal (CSI-RS) resource mapping configuration, the CSI-RS resource mapping being comprised in a non-zero-power (NZP) CSI-RS resource (NZP-CSI-RS-Resource) configuration.

9. The apparatus of claim 1, wherein the at least one processor, individually or in any combination, is configured to receive the second indication comprised in at least one non-zero-power (NZP) channel state information (CSI) reference signal (RS) resource (NZP-CSI-RS-Resource) configuration.

10. The apparatus of claim 9, wherein each NZP-CSI-RS-Resource configuration of the at least one NZP-CSI-RS-Resource configuration indicates a starting physical resource block (PRB) and a number of PRBs for corresponding frequency occupations of the one or more frequency occupations.

11. The apparatus of claim 10, wherein, based on the starting PRB and the number of PRBs indicated for at least the corresponding frequency occupations of the one or more frequency occupations, the corresponding frequency occupations comprise PRBs outside an active bandwidth part (BWP).

12. The apparatus of claim 1, wherein a first frequency occupation of the one or more frequency occupations comprises a subset of non-contiguous physical resource blocks (PRBs) in an active bandwidth part (BWP), wherein the second indication indicates the subset of non-contiguous PRBs in the active BWP by indicating one of an even PRB occupation or an odd PRB occupation via a density configuration comprised in a channel state information reference signal (CSI-RS) resource mapping configuration that is in turn comprised in a non-zero-power (NZP) CSI-RS resource (NZP-CSI-RS-Resource) configuration.

13. The apparatus of claim 1, wherein the second indication comprises an indication of one or more measurement resource frequency occupations having a defined correspondence to the one or more frequency occupations.

14. The apparatus of claim 13, wherein the defined correspondence comprises a correspondence between the one or more frequency occupations and a reference set of frequency-domain resources based on a scaling factor applied to one of a union of the one or more measurement resource frequency occupations or an intersection of the one or more measurement resource frequency occupations.

15. The apparatus of claim 1, the at least one processor, individually or in any combination, is further configured to:
predict at least one channel characteristic value based on resources indicated in the first indication and the second indication.

16. The apparatus of claim 15, wherein the at least one processor, individually or in any combination, is configured to predict the at least one channel characteristic value using at least one defined energy per resource element (EPRE) offset from a corresponding at least one of a synchronization signal block (SSB) EPRE, a transmitted non-zero power channel state information reference signal (NZP-CSI-RS) EPRE, a physical downlink shared channel (PDSCH) EPRE, or a demodulation reference signal (DMRS) EPRE.

17. An apparatus for wireless communication at a network node, comprising:
at least one memory; and
at least one processor coupled to the at least one memory and, based at least in part on information stored in the at least one memory, the at least one processor, individually or in any combination, is configured to:
provide, for a wireless device, a first indication of one or more resources for at least one channel characteristic prediction;
provide, for the wireless device, a second indication of one or more frequency occupations for the at least one channel characteristic prediction for the one or more resources;
skip transmission of a reference signal in resources configured by the first indication and the second indication; and
obtain, from the wireless device, a third indication of at least one predicted channel characteristic value for at least one of the one or more frequency occupations and a corresponding at least one of the one or more resources.

18. The apparatus of claim 17, wherein the at least one predicted channel characteristic value associated with the at least one channel characteristic prediction for a first frequency occupation of the one or more frequency occupations associated with a first spatial-domain resource of the one or more resources includes at least one of a predicted layer 1 reference signal received power (L1-RSRP) that is based on a linear average of a predicted RSRP for at least one resource element (RE) associated with the first frequency occupation, a predicted layer 1 signal to interference and noise ratio (L1-SINR) that is based on a linear average of a predicted SINR for the at least one RE associated with the first frequency occupation, or a channel quality indicator (CQI) associated with the first spatial-domain resource.

19. The apparatus of claim 17, wherein the one or more frequency occupations indicate frequency-domain resources based on at least one of:
a first set of contiguous physical resource blocks (PRBs) in an active bandwidth part (BWP),
a second set of non-contiguous PRBs in the active BWP,
each PRB within the active BWP, or
a third set of PRBs spanning a frequency range that is greater than the active BWP.

20-28. (canceled)

29. A method of wireless communication at a wireless device, comprising:
receiving, from a network node, a first indication of one or more resources for at least one channel characteristic prediction;
receiving, from the network node, a second indication of one or more frequency occupations for the at least one channel characteristic prediction for the one or more resources for which the network node refrains from transmitting a reference signal; and
indicating, to the network node, at least one predicted channel characteristic value for at least one of the one or more frequency occupations and a corresponding at least one of the one or more resources.

30. (canceled)
